(19) United States
(12) Patent Application Publication
(10) Pub. No.: US 2026/0005872 A1
(43) Pub. Date: Jan. 1, 2026

(54) DATA PROCESSING METHOD AND APPARATUS BASED ON BLOCKCHAIN

(71) Applicant: TENCENT TECHNOLOGY (SHENZHEN) COMPANY LIMITED, Shenzhen (CN)

(72) Inventor: Zhuguang SHAO, Shenzhen (CN)

(21) Appl. No.: 19/320,800

(22) Filed: Sep. 5, 2025

Related U.S. Application Data
(63) Continuation of application No. PCT/CN2024/072020, filed on Jan. 12, 2024.

(30) Foreign Application Priority Data
Jul. 3, 2023 (CN) 202310809879.3

(51) Int. Cl. H04L 9/32; H04L 9/00

(52) U.S. Cl. CPC H04L 9/3255; H04L 9/321; H04L 9/50

(57) ABSTRACT

Disclosed in embodiments of this application are a data processing method and apparatus based on a blockchain, and a device and a medium. The method includes obtaining a node weight update instruction generated for the first consensus node in a blockchain network, the node weight update instruction being configured for instructing an update of a node weight configured for voting information of the first consensus node in a consensus service; predicting whether an updated node weight of the first consensus node meets a node update condition based on the node weight update instruction to obtain a prediction result; updating the node weight of the first consensus node according to the node weight update instruction in response to the prediction result being positive to obtain an update result; and recording the update result in a database of the blockchain network.

### RELATED APPLICATIONS

This application is a continuation of PCT Application No. PCT/CN 2024/072020, filed on Jan. 12, 2024, which claims priority to Chinese Patent Application No. 202310809879.3, filed to the China National Intellectual Property Administration on Jul. 3, 2023 and entitled “DATA PROCESSING METHOD AND APPARATUS BASED ON BLOCKCHAIN, AND DEVICE AND MEDIUM”, which are both incorporated by reference in their entirety.

### FIELD OF THE TECHNOLOGY

This application relates to the field of blockchain network technology, and in particular, to a data processing method and apparatus based on a blockchain, and a device and a medium.

### BACKGROUND OF THE DISCLOSURE

When deploying a traditional blockchain network, if a certain service organization (e.g., Organization 1) wants to have greater decision-making power in the whole blockchain network, more consensus nodes need to be deployed in the blockchain network for Organization 1, i.e., a participation weight of Organization 1 needs to be increased by increasing a quantity of nodes of Organization 1. However, since each consensus node in the blockchain network has an independent database and these databases may be in different servers, more computing and memory resources typically need to be consumed. For example, when a new consensus node is added to the blockchain network, a series of configuration operations are required, such as configuring a consensus algorithm for the new consensus node, configuring a network connection relationship with the existing consensus nodes, and configuring a maintained database. Implementations of these configuration operations consume lot of resources. Moreover, increasing the quantity of consensus nodes will inevitably increase a consensus calculation amount of the blockchain network and a network traffic, which leads to an increase in a resource consumption of the blockchain network. In addition, blockchain network nodes are complicated programs, which means that node management will be more complicated. That is, a traditional deployment mode not only increases the workload of node deployment, but also increases the resource consumption of the blockchain network and a difficulty in node management.

### SUMMARY

Embodiments of this application provide a data processing method and apparatus based on a blockchain, and a device and a medium, which can reduce a workload of node deployment without additionally increasing resource consumption of a blockchain network and a difficulty in node management.

One aspect of the embodiments of this application provides a data processing method based on a blockchain, including obtaining a node weight update instruction generated for the first consensus node in a blockchain network, the node weight update instruction being configured for instructing an update of a node weight configured for voting information of the first consensus node in a consensus service; predicting whether an updated node weight of the first consensus node meets a node update condition based on the node weight update instruction to obtain a prediction result; updating the node weight of the first consensus node according to the node weight update instruction in response to the prediction result being positive to obtain an update result; and recording the update result in a database of the blockchain network.

Another aspect of this application provides a blockchain network, including N consensus nodes. N is a positive integer. One consensus node corresponds to one node weight. The N consensus nodes include the first consensus node and a target consensus node. The target consensus node is configured to obtain a node weight update instruction generated for the first consensus node in the blockchain network, and the node weight update instruction is configured for instructing an update of a node weight configured for voting information of the first consensus node in a consensus service. The target consensus node is further configured to predict whether an updated node weight of the first consensus node meets a node update condition based on the node weight update instruction, to obtain a prediction result. The target consensus node is further configured to update the node weight of the first consensus node according to the node weight update instruction in response to the prediction result being positive, to obtain an update result, and record the update result in a database of the blockchain network.

Another aspect of this application provides a computer device, including: a processor, a memory, and a network interface.

The processor is connected to the memory and the network interface. The network interface is configured to provide a data communication function. The memory is configured to store a computer program. The processor is configured to invoke the computer program, to cause the computer device to perform the method provided in the embodiments of this application.

An aspect of the embodiments of this application provides a non-transitory computer-readable storage medium, having a computer program stored therein. The computer program is adapted to be loaded and executed by a processor, to cause a computer device having the processor to perform the method provided in the embodiments of this application.

In the embodiments of this application, the target consensus node can obtain the node weight update instruction generated for the first consensus node in the blockchain network. The node weight update instruction is configured for instructing the update of the node weight configured for the voting information of the first consensus node in the consensus service. If the service organization having the first consensus node wants to change decision-making power in the whole blockchain network, the target consensus node can predict whether the updated node weight of the first consensus node meets the node update condition based on the node weight update instruction, to obtain the prediction result. the target consensus node can obtain the update result. In response to the prediction result being positive, the target consensus node can update the node weight of the first consensus node according to the node weight update instruction, and record the update result in the database of the blockchain network.

This means that if the service organization wants to have greater decision-making power in the whole blockchain network, there is no need to increase the number of nodes of the service organization. Instead, based on the node weight, the node weight of the first consensus node is adjusted to change the weight of voting information initiated by the first consensus node in a process of participating in the consensus service. When a new consensus node is added to the blockchain network, a series of configuration operations are required, such as configuring a consensus algorithm for the new consensus node, configuring a network connection relationship with existing consensus nodes, and configuring a maintained database. Implementation of these configuration operations consumes a lot of resources. Moreover, increasing the number of consensus nodes will inevitably increase the consensus calculation amount of the blockchain network and the network traffic, which leads to an increase in resource consumption of the blockchain network.

A deployment mode of changing the node weight in this application does not need to add the new consensus node, so there is no need to perform the above configuration operations, which can reduce the workload of node deployment. Moreover, since the quantity of consensus nodes in the blockchain network is not increased, resource consumption of the blockchain network will not be increased. In addition, since the quantity of consensus nodes maintained and managed is not increased, the difficulty level in maintaining and managing the consensus nodes will not be increased.

### BRIEF DESCRIPTION OF THE DRAWINGS

To describe the technical solutions of the embodiments of this application or the related art more clearly, the following briefly introduces the accompanying drawings required for describing the embodiments or the related art. Apparently, the accompanying drawings in the following description show only some embodiments of this application, and a person of ordinary skill in the art may still derive other accompanying drawings from these accompanying drawings without creative efforts.

FIG. 1 is a schematic diagram of a blockchain network structure according to an embodiment of this application.

FIG. 2 is a schematic diagram of a scenario of performing data exchanging according to an embodiment of this application.

FIG. 3 is a schematic flowchart of a data processing method based on a blockchain according to an embodiment of this application.

FIG. 4 is a schematic diagram of a scenario of checking a node weight update instruction according to an embodiment of this application.

FIG. 5 is a schematic flowchart of a consensus algorithm according to an embodiment of this application.

FIG. 6 is a schematic diagram I of a scenario of updating a node weight of the first consensus node according to an embodiment of this application.

FIG. 7 is a schematic diagram II of a scenario of updating a node weight of the first consensus node according to an embodiment of this application.

FIG. 8 is a schematic diagram III of a scenario of updating the node weight of the first consensus node according to an embodiment of this application.

FIG. 9 is a schematic diagram of a scenario of transaction on-chaining according to an embodiment of this application.

FIG. 10 is a schematic diagram of a scenario of a service consensus according to an embodiment of this application.

FIG. 11 is a schematic flowchart of a data processing method based on a blockchain according to an embodiment of this application.

FIG. 12 is a schematic diagram of a scenario of taking turns to serve as a master node according to an embodiment of this application.

FIG. 13 is a schematic flowchart of a data processing method based on a blockchain according to an embodiment of this application.

FIG. 14 is a schematic structural diagram of a data processing apparatus based on a blockchain according to an embodiment of this application.

FIG. 15 is a schematic diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the embodiments described are merely some rather than all of the embodiments of this application. All other embodiments obtained by a person of ordinary skill in the art based on the embodiments of this application without creative efforts shall fall within the protection scope of this application.

Embodiments of this application provide a consensus voting processing solution based on a blockchain. A blockchain (or block chain) network can be a series of textual records (also referred to as blocks) that are concatenated and protect content by cryptography, i.e., it includes a series of blocks that are connected with each other according to a chronological order of generation. Once a new block is added to the blockchain network, it will not be removed. Each block may include a cryptographic hash of the previous block (i.e., a hash value of a parent block), a generation timestamp, and transaction data (which may also be referred to as service data, and is usually represented by a hash value calculated by a Merkle tree algorithm), which makes the content of the block difficult to tamper with. Distributed databases concatenated by a blockchain network technology can enable both parties to effectively record a transaction and permanently check this transaction (that is, service data).

Smart contracts are applications or programs that run on nodes of the blockchain network. Typically, they are a set of digital protocols which have specific rules and can be enforced. These rules are predefined by computer source codes, and all network nodes can copy and execute these computer source codes.

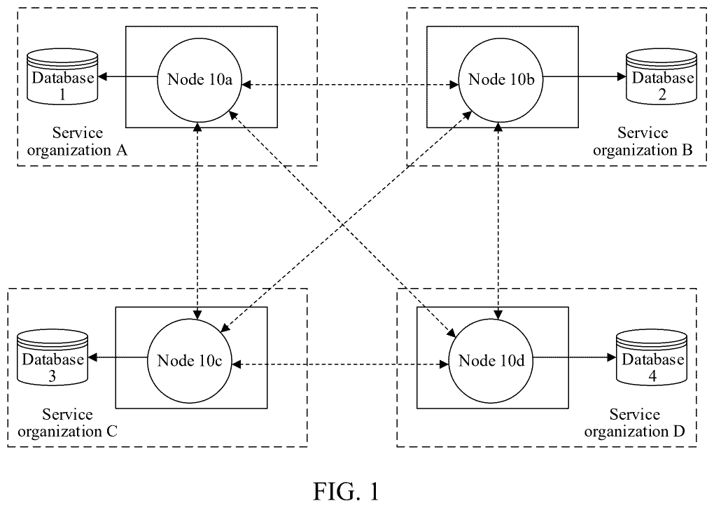

Referring to FIG. 1, FIG. 1 is a schematic diagram of a blockchain network structure according to an embodiment of this application. The blockchain network structure may be applied to a blockchain network system. The blockchain network system may include a distributed system formed by connecting N consensus nodes in a form of network communication. N is a positive integer. The consensus nodes here may be servers connected to the blockchain network or terminal devices connected to the blockchain network, and a specific form of the consensus nodes is not limited here. One consensus node may correspond to one service organization, and each consensus node has an independent database which may also be referred to as a blockchain ledger.

The consensus node refers to a node running a blockchain network consensus protocol, and has block production and voting permissions. The consensus node can participate in checking and broadcasting transaction data and block information, and can detect and maintain connections with other consensus nodes. At the same time, the consensus node may also include a complete blockchain network database. The N consensus nodes shown in FIG. 1 can take turns to serve as a master node having a proposal function in the blockchain network based on a block producing rule associated with the blockchain network, to participate in the generation, broadcasting and consensus of the new block.

A consensus algorithm is one of core technologies of the blockchain network. The consensus algorithm is a specification that the blockchain network nodes (i.e., consensus nodes) follow. Consensus algorithms commonly used in an industry at present include Proof-of-Work (i.e., PoW), Proof-of-Stake (i.e., PoS), Byzantine Fault Tolerance (e.g., TBFT), and the like. Among them, TBFT is TendermintBFT consensus algorithm, which is a Byzantine Fault Tolerance consensus algorithm, and the nodes it supports need to meet a node configuration rule that N is equal to 3F+1, where F represents a maximum quantity of malicious nodes (i.e., illegal nodes) allowed in the blockchain network. If a quantity of malicious nodes allowed in the blockchain network exceeds this maximum quantity, a security of the whole network will be reduced or the whole network may even be unavailable. The illegal nodes here may not transmit messages, or may transmit inconsistent messages in an attempt to disrupt other consensus nodes. The consensus algorithm can allow illegal nodes to delay network transmission between normal nodes, and can provide security and activity in a case that there are less than ⅓ of illegal nodes. For example, in the blockchain network system shown in FIG. 1, when there are not less than (2F+1) valid consensus nodes working normally, the nodes in the blockchain network may reach agreement. For example, the maximum quantity of illegal nodes allowed in the blockchain network system of 4 consensus nodes is 1.

For ease of description, as shown in FIG. 1, a total quantity N of nodes in the blockchain network may be 4. The 4 consensus nodes may specifically include a node 10a corresponding to a service organization A, a node 10b corresponding to a service organization B, a node 10c corresponding to a service organization C, and a node 10d corresponding to a service organization D. Each service organization may correspond to one or more of service objects (i.e., organization members). A database corresponding to the node 10a is Database 1. A database corresponding to the node 10b is Database 2. A database corresponding to the node 10c is Database 3. A database corresponding to the node 10d is Database 4.

Each of the 4 consensus nodes in the blockchain network shown in FIG. 1 may correspond to one node weight. For example, a node weight of the node 10a is configured for indicating the weight of voting information initiated by the node 10a in the process of participating in a consensus service in the blockchain network. A node weight of the node 10b is configured for indicating the weight of voting information initiated by the node 10b in the process of participating in the consensus service in the blockchain network. A node weight of the node 10c is configured for indicating a weight of voting information initiated by the node 10c in the process of participating in the consensus service in the blockchain network. A node weight of the node 10d is configured for indicating the weight of voting information initiated by the node 10d in the process of participating in the consensus service in the blockchain network. The node weights of any two consensus nodes in the blockchain network may be the same or different, which is not limited here.

If one of 4 service organizations (e.g., the service organization A) wants to change decision-making power in the whole blockchain network, in this embodiment, the service organization A may be referred to as the first service organization, and the node 10a corresponding to the service organization A may be referred to as a consensus node of a weight to be configured. For ease of distinction, in this embodiment, the consensus node of weight to be configured in the blockchain network may be referred to as the first consensus node, and consensus nodes other than the first consensus node in the blockchain network may be referred to as third consensus nodes. If it is detected that there is a consensus node in an abnormal state in the blockchain network, a detected consensus node in the abnormal state may be referred to as the second consensus node in this embodiment.

For ease of description, in this embodiment, any service object belonging to the service organization A may be referred to as the first object, and a terminal device corresponding to the first object may be referred to as the first terminal device. The first terminal device can generate a node weight update instruction when responding to a configuration operation of the first object for the node weight of the node 10a. The node weight update instruction is configured for instructing an update of a node weight configured for voting information of the first consensus node in the consensus service. The node weight update instruction may also be interpreted as a transaction in a blockchain service configured for requesting the update of the node weight of the first consensus node.

A target consensus node (e.g., a master node having a proposal function) in the blockchain network can obtain the node weight update instruction for the node 10a to predict whether an updated node weight of the first consensus node meets a node update condition based on the node weight update instruction (specifically, according to a prediction rule), to obtain a prediction result. The prediction rule here may be the first prediction rule (for example, a strong rule) or the second prediction rule (for example, a weak rule). The strong rule means that after a consensus node updates its weight, even if an abnormality occurs in the consensus node subsequently, it cannot affect a normal consensus of the whole blockchain network. That is, in this case, the node update condition may be a condition that the updated node weight of the first consensus node does not affect the normal consensus of the blockchain network. The prediction result may be positive or negative. A positive result may indicate that the predicted updated node weight of the first consensus node meets the node update condition, and the positive result may also indicate that an updated node weight of the first consensus node does not affect the normal consensus of the blockchain network. A negative result may indicate that the predicted updated node weight of the first consensus node does not meet the node update condition, and the negative result may also indicate that the updated node weight of the first consensus node affects the normal consensus of the blockchain network.

For the weak rule, there is no control in a node weight update process, i.e., it can be directly determined that a node weight of an updated first consensus node meets the node update condition based on the node weight update instruction, but there will be strict requirements in the subsequent consensus stage. In this case, the node update condition may be a condition that the node weight of the first consensus node is allowed to be updated by default. The prediction result can only be the positive result. The positive result may indicate that the predicted updated node weight of the first consensus node meets the node update condition, and the positive result may also indicate that the node weight of the first consensus node is allowed to be updated.

Further, in response to the prediction result being positive, the node weight of the node 10a may be updated according to a configuration weight carried by the node weight update instruction to obtain an update result, and further, the update result may be written into a database in the blockchain network. The update result written into the database in the blockchain network may also be interpreted as a transaction execution result written into the blockchain ledger (the update result may be written into the database in a form of a block, which may further include the node weight update instruction). That is, all the consensus nodes in the blockchain network will accept the update result written into the database in the blockchain network, i.e., accept the updated node weight of the first consensus node. The node weight of the node 10a in the update result is configured for indicating the weight of voting information initiated by the node 10a in the process of participating in the consensus service. For example, if the node weight of the node 10a is updated to 2, it means that a quantity of votes corresponding to voting information generated by the node 10a in the subsequent consensus stage is equivalent to 2.

As can be seen, this embodiment provides a processing model in which the nodes in the blockchain network support the weights themselves. When the first service organization needs to have greater decision-making power, there is no need to increase a quantity of nodes corresponding to the first service organization. Instead, the node weight of the first consensus node is changed to change the weight of voting information initiated by the first consensus node in the process of participating in the consensus service. A deployment mode of changing the node weight in this application does not need to add a new consensus node, so there is no need to perform various configuration operations required for creating the new consensus node, which can reduce a workload of node deployment. Moreover, since the quantity of consensus nodes in the blockchain network is not increased, resource consumption of the blockchain network will not be additionally increased. In addition, since the quantity of consensus nodes maintained and managed is not increased, a difficulty in maintaining and managing the consensus nodes will not be increased.

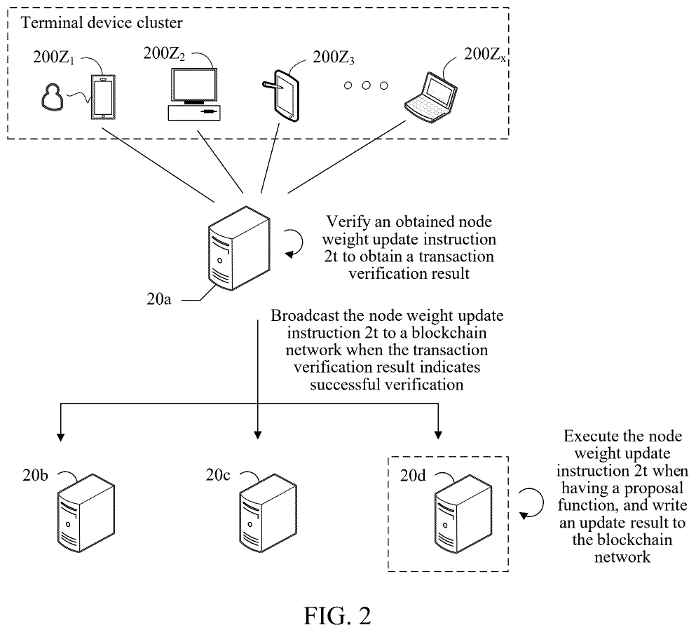

For ease of understanding, further, referring to FIG. 2, FIG. 2 is a schematic diagram of a scenario of performing data exchanging according to an embodiment of this application. As shown in FIG. 2, in this embodiment, a total quantity of consensus nodes in the blockchain network may be 4, which may specifically include a node 20a, a node 20b, a node 20c, and a node 20d. One consensus node may correspond to one service organization, and each service organization may include one or more service objects.

A terminal device cluster shown in FIG. 2 may be a terminal device cluster corresponding to a service organization (for example, a service organization A) corresponding to the node 20a. The terminal device cluster may include terminal devices corresponding to X service objects (i.e., members belonging to the service organization A), which may specifically include a terminal device 200Z₁ corresponding to an object A₁, a terminal device 200Z₂ corresponding to an object A₂, a terminal device 200Z₃ corresponding to an object A₃, . . . , and a terminal device 200Zₓ corresponding to an object Aₓ.

Each terminal device in the terminal device cluster may include: a smartphone, a tablet computer, a notebook computer, a desktop computer, a smart speaker, a smartwatch, an on-board terminal, a smart television, and other smart terminals having data processing functions. A service application (i.e., application client) may be installed on each terminal device in the terminal device cluster shown in FIG. 2. When the application client runs in each terminal device, it may exchange data with the node 20a shown in FIG. 2 above. The application client may include a social client, a multimedia client (e.g., a video client), an entertainment client (e.g., a gaming client), an information stream client, an education client, a live streaming client, and other application clients. The application client may be an independent client, or may be an embedded sub-client integrated in a specific client (for example, the social client, the education client, and the multimedia client), which is not limited herein.

The terminal device corresponding to each service object may establish a network connection with the node 20a to perform data exchanging with the node 20a through the network connection. There is no limitation to the mode of the network connection, which may be direct or indirect connection in a wired communication mode, direct or indirect connection in a wireless communication mode or other connection modes, which is not limited here in this application.

When the service organization A needs to change decision-making power in the whole blockchain network, any service object belonging to the service organization A may generate a node weight update instruction (e.g., a node weight update instruction 2t shown in FIG. 2) for the node 20a by using a used terminal device.

For example, the object A₁ (i.e., the first object) may determine a configuration weight corresponding to the node 20a on the terminal device 200Z₁, and perform a configuration operation for a node weight of the node 20a after completing the determination, such that the terminal device 200Z₁ (i.e., the first terminal device) generates the node weight update instruction 2t (the node weight update instruction 2t may carry the configuration weight) for the node 20a in response to the configuration operation. The configuration operation here may include a contact operation such as clicks/taps and long presses, and may also include a non-contact operation such as a voice or a gesture, which is not limited here.

The configuration weight here is determined based on a percentage that the service organization A wants its consensus nodes to account for in the whole blockchain environment and a total node weight in the blockchain network. The configuration weight may be directly inputted by the object A₁ on a weight configuration interface (i.e., a terminal interface for weight configuration) of the terminal device 200Z₁, or may be selected by the object A₁ from a plurality of candidate weights provided by the weight configuration interface of the terminal device 200Z₁, or may be automatically calculated by the terminal device 200Z₁ based on a percentage inputted by the object A₁ on the weight configuration interface of the terminal device 200Z₁ and the total node weight in the blockchain network. Certainly, the configuration weight may also include another determining mode, which is not limited here. For example, if the percentage inputted by the object A₁ on the weight configuration interface of the terminal device 200Z₁ is 40% and the node weight of each consensus node in the blockchain network is 1, which means that the total node weight in the blockchain network is 4, then the terminal device 200Z₁ may automatically determine that the configuration weight corresponding to the node 20a is 2 (it is predicted that the total node weight after the node weight is updated becomes 5, and the configuration weight is 2, which therefore can meet that the percentage of the node weight of the node 20a in the whole blockchain network is 40%), and then generate the node weight update instruction 2t for requesting a change of the node weight of the node 20a to the configuration weight.

Further, the terminal device 200Z₁ may transmit the node weight update instruction 2t to the node 20a (i.e., the first consensus node) in the blockchain network such that the node 20a performs verification (including validity checking and multi-signature verification) on an obtained node weight update instruction 2t, to obtain a transaction verification result. In this embodiment, a verification result of performing validity verification (i.e., verifying an instruction format and master signature information) on the node weight update instruction 2t may be referred to as a validity verification result, and a verification result of performing multi-signature verification (i.e., verifying multi-party signature information) on the node weight update instruction 2t may be referred to as a multi-signature verification result. If the validity verification result indicates that the node weight update instruction 2t is valid and the multi-signature verification result indicates successful verification, it means that the transaction verification result here indicates successful verification. If the validity verification result indicates that the node weight update instruction 2t is valid but the multi-signature verification result indicates failed verification, it means that the transaction verification result here indicates failed verification. If the validity verification result indicates that the node weight update instruction 2t is not valid, there is no need to perform multi-signature verification on the node weight update instruction 2t, and it may be directly determined that the transaction verification result indicates failed verification. When the transaction verification result indicates failed verification, the node 20a may directly discard the node weight update instruction 2t.

When the transaction verification result indicates successful verification, the node 20a may broadcast the node weight update instruction 2t to other nodes (i.e., the third consensus nodes) in the blockchain network, i.e., may broadcast the node weight update instruction 2t respectively to the node 20b, the node 20c, and the node 20d shown in FIG. 2, to wait for the master node having the proposal function in the blockchain network (i.e., the target consensus node) to execute the node weight update instruction 2t, to obtain an update result corresponding to the node weight update instruction 2t. Then, the master node may write the update result and the node weight update instruction 2t into the blockchain network when the consensus nodes in the blockchain network reach a consensus.

For example, if the master node having the proposal function in the blockchain network is the node 20d, the node 20d may predict whether the updated node weight of the first consensus node meets a node update condition based on the node weight update instruction, to obtain a prediction result, and may update the node weight of the node 20a based on a configuration weight carried by the node weight update instruction 2t in response to the prediction result being positive, to obtain an update result. Then, the node 20d may write the update result and the node weight update instruction 2t into the blockchain network when the consensus nodes in the blockchain network reach a consensus.

If the node weight of the node 20a is 1, then the node 20d may update the node weight of the node 20a to the configuration weight based on the configuration weight carried by the node weight update instruction 2t. The node weight of the node 20a in the update result is configured for indicating the weight of voting information initiated by the node 20a in a process of participating in the consensus service. That is, when the configuration weight is 2, it means that one piece of voting information initiated by the node 20a in the process of participating in the consensus service is equivalent to two pieces.

As can be seen, when the service organization A needs to have greater decision-making power, according to the deployment mode provided in this embodiment, there is no need to increase the quantity of nodes corresponding to the service organization A. Instead, the node weight of the node 10a is changed to change the weight of voting information initiated by the node 10a in the process of participating in the consensus service. The deployment mode of changing the node weight in this application does not need to add a new consensus node, so there is no need to perform various configuration operations required for creating the new consensus node, which can reduce the workload of node deployment. Moreover, since the quantity of consensus nodes in the blockchain network is not increased, resource consumption of the blockchain network will not be additionally increased. In addition, since the quantity of consensus nodes maintained and managed is not increased, the difficulty in maintaining and managing the consensus nodes will not be increased.

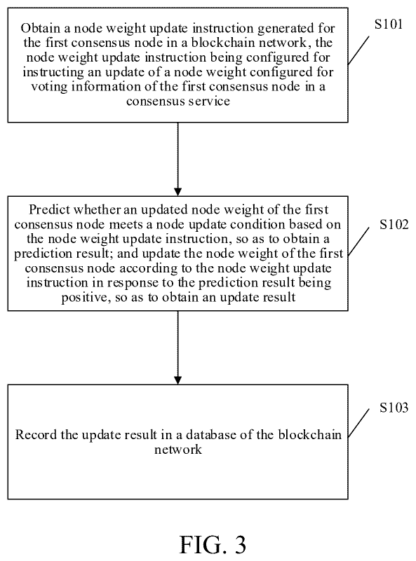

For a specific implementation mode of deploying nodes in the blockchain network based on an idea of the weight in this embodiment, reference may be made to the embodiments corresponding to FIG. 3 to FIG. 13 below.

Further, referring to FIG. 3, FIG. 3 is a schematic flowchart of a data processing method based on a blockchain according to an embodiment of this application. As shown in FIG. 3, the method may be performed by a target consensus node. The target consensus node may be the master node having the proposal function in the blockchain network shown in FIG. 1 above. The target consensus node may be the first consensus node (e.g., the node 10a shown in FIG. 1 above) or the third consensus node (e.g., any consensus node in the node 10b, the node 10c, or the node 10d). The target consensus node is not limited here. The method may include at least the following operations S101 to S103:

Operation S101: Obtain a node weight update instruction generated for the first consensus node in a blockchain network, the node weight update instruction being configured for instructing an update of a node weight configured for voting information of the first consensus node in a consensus service.

The first consensus node here belongs to N consensus nodes included in the blockchain network. The N consensus nodes may include the first consensus node and the third consensus node. N is a positive integer, and one consensus node corresponds to one service organization. A service organization corresponds to the first consensus node is the first service organization. The first service organization refers to a service organization that wants to change decision-making power in the whole blockchain network. The node weight update instruction here is generated by the first terminal device of the first service organization in response to a configuration operation of the first object for the node weight of the first consensus node. The node weight update instruction obtained by the target consensus node may be directly transmitted by the first terminal device, or broadcast by another node in the blockchain network after successful verification, which is not limited here.

Each of the N consensus nodes in the blockchain network may correspond to one node weight. For example, when the node weight of each consensus node is 1, the total quantity of nodes in the blockchain network is a total node weight in the blockchain network. When the first service organization needs to change decision-making power, the first object may determine, on the first terminal device, a to-be-configured node weight of the first consensus node based on a percentage that the first service organization wants to account for in the blockchain network and the total node weight in the blockchain network. For example, if node weights of 3 consensus nodes are all 1, the percentage that the first service organization wants to account for in the blockchain network is 50%, and the total node weight in the blockchain network is 3, then the to-be-configured node weight of the first consensus node determined by the first object is 2.

Then, the first object may perform a configuration operation for the node weight of the first consensus node on the first terminal device, such that the first terminal device determines the to-be-configured node weight of the first consensus node determined by the first object as the configuration weight when responding to the configuration operation, and may further generate a service transaction for requesting a change of the node weight of the first consensus node (i.e., the node weight update instruction) based on the configuration weight. In this case, the first terminal device may sign the node weight update instruction based on an object private key of the first object (i.e., the first private key) to obtain master signature information corresponding to the node weight update instruction.

Since the blockchain network includes the N consensus nodes, and one consensus node corresponds to one service organization, this means that the blockchain network is related to N service organizations. In this embodiment, service organizations other than the first service organization in the N service organizations may be referred to as second service organizations. Based on this, the first terminal device may transmit the node weight update instruction including the master signature information respectively to second terminal devices corresponding to second objects belonging to the second service organizations, such that the second terminal devices receiving the node weight update instruction including the master signature information return signature parameters for performing multi-party signature on the node weight update instruction based on object private keys of the second objects (i.e., second private keys).

The first terminal device may count a quantity of signature organizations M receiving the signature parameters. When the quantity of signature organizations M is greater than a signature threshold (e.g., 2N/3), the first terminal device may aggregate M signature parameters to obtain multi-party signature information of the node weight update instruction, and further transmit the node weight update instruction including the multi-party signature information and the master signature information to the blockchain network. This means that the multi-party signature information in this embodiment is obtained after performing multi-party signature on the node weight update instruction based on the second private keys of the second objects associated with the M second service organizations.

The target consensus node here may be the first consensus node or the third consensus node (i.e., another consensus node other than the first consensus node). If the target consensus node is the first consensus node, then the target consensus node may directly receive the node weight update instruction transmitted by the first terminal device. The node weight update instruction carries the master signature information and the multi-party signature information. Then, the target consensus node may perform validity verification on the node weight update instruction based on the first public key of the first object and the master signature information to obtain a validity verification result. When performing validity verification on the node weight update instruction, the target consensus node may perform signature verification on the master signature information based on the first public key of the first object to obtain a master signature verification result. Further, the target consensus node also needs to check the instruction format of the node weight update instruction based on a smart contract on the blockchain network to obtain a checking result. If the master signature verification result indicates successful verification and the checking result indicates successful checking, the target consensus node may generate the validity verification result for indicating that the node weight update instruction is valid. If the master signature verification result indicates failed verification or the checking result indicates failed checking, the target consensus node may generate the validity verification result for indicating that the node weight update instruction is not valid.

If the validity verification result indicates that the node weight update instruction is valid, the target consensus node further needs to continue to perform multi-signature verification on the multi-party signature information based on second public keys respectively corresponding to the second objects associated with the M second service organizations to obtain a multi-signature verification result, and when the multi-signature verification result indicates successful verification, the target consensus node may broadcast the node weight update instruction to other nodes (e.g., the third consensus node) in the blockchain network. When the multi-signature verification result indicates successful verification, the target consensus node may further perform operation S102 below.

In some embodiments, if the target consensus node is the third consensus node (i.e., not the first consensus node), the node weight update instruction obtained by the target consensus node is committed by the first consensus node when determining that the multi-signature verification result indicates successful verification. The multi-signature verification results here is obtained by the first consensus node after performing multi-signature verification on the multi-party signature information carried in the node weight update instruction when determining that the validity verification result indicates that the node weight update instruction is valid. The validity verification results here is generated by the first consensus node after performing validity verification on a received node weight update instruction.

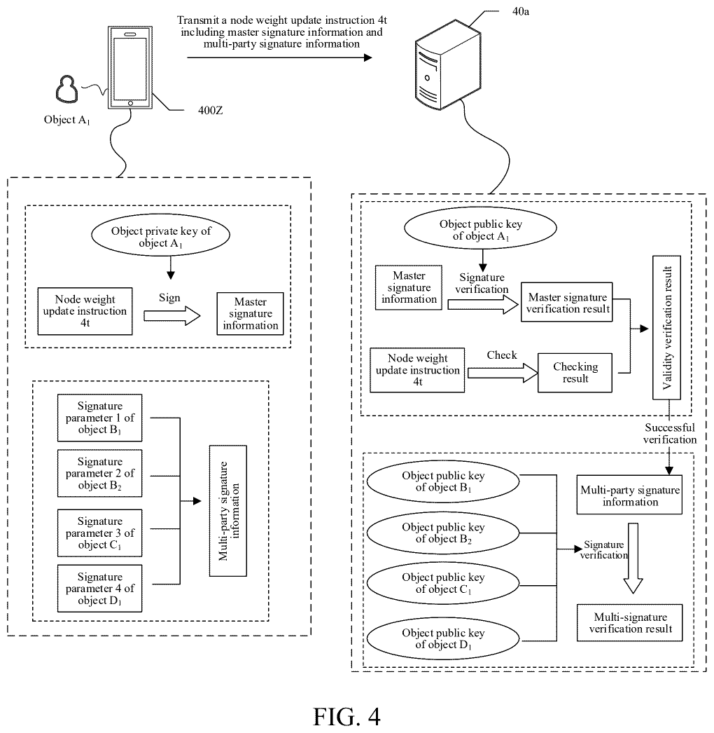

For ease of understanding, further, referring to FIG. 4, FIG. 4 is a schematic diagram of a scenario of checking the node weight update instruction according to an embodiment of this application. As shown in FIG. 4, an object A₁ corresponding to a terminal device 400Z here is a member belonging to the service organization A (i.e., the first service organization). The node corresponding to the service organization A in the blockchain network is a node 40a shown in FIG. 4. The node 40a here may be the node 10a in the blockchain network in the embodiment corresponding to FIG. 1 above. Service organizations associated with the blockchain network to which the node 40a belongs may further include, in addition to the service organization A, second service organizations, for example, a service organization B, a service organization C, and a service organization D.

When generating a node weight update instruction 4t shown in FIG. 4, the terminal device 400Z belonging to the service organization A may sign the node weight update instruction 4t based on an object private key of the object A₁ (i.e., the first private key) to obtain master signature information corresponding to the node weight update instruction 4t. The terminal device 400Z may obtain a hash calculation rule. The hash calculation rule may be a digest algorithm agreed on by the terminal device 400Z and other blockchain network nodes in the blockchain network in advance. The terminal device 400Z may perform hash calculation on the node weight update instruction 4t based on the hash calculation rule to obtain digest information (i.e., digest information h) of the node weight update instruction 4t. In this embodiment, the digest information of the node weight update instruction 4t determined by the terminal device 400Z may be referred to as first digest information. Further, the terminal device 400Z may sign the first digest information based on the object private key of the object A₁ to obtain the master signature information shown in FIG. 4.

Then, the terminal device 400Z may transmit the node weight update instruction 4t including the master signature information respectively to the second terminal device corresponding to the second object belonging to the service organization B, the second terminal device corresponding to the second object belonging to the service organization C, and the second terminal device corresponding to the second object belonging to the service organization D, such that the second terminal devices respectively return signature parameters for performing multi-party signature on the node weight update instruction 4t based on the second private key of the second object corresponding to itself. The signature parameters returned by multiple second terminal devices belonging to the same second service organization to the terminal device 400Z may all be considered as signature parameters returned by the same signature organization.

For example, if signature parameters received by the terminal device 400Z include a signature parameter 1 of an object B₁ (e.g., a signature parameter returned by the terminal device corresponding to the object B₁), a signature parameter 2 of the object B₂ (e.g., a signature parameter returned by the terminal device corresponding to the object B₂), a signature parameter 3 of an object C₁ (e.g., a signature parameter returned by the terminal device corresponding to the object C₁), and a signature parameter 4 of an object D₁ (e.g., a signature parameter returned by the terminal device corresponding to the object D₁), where the object B₁ and the object B₂ are both members belonging to the service organization B, the object C₁ is a member belonging to the service organization C, and the object Di is a member belonging to the service organization D, it means that a quantity of signature organizations M counted by the terminal device 400Z is 3, namely the service organization B, the service organization C, and the service organization D.

Since the quantity of signature organizations, which is 3, is greater than the signature threshold (e.g., 2N/3), the terminal device 400Z may aggregate 3 signature parameters to obtain the multi-party signature information of the node weight update instruction 4t. Then, the terminal device 400Z may transmit the node weight update instruction 4t including the multi-party signature information and the master signature information to the consensus node corresponding to the service organization A (i.e., the first consensus node in the blockchain network, for example, the node 40a), such that the node 40a performs verification on the node weight update instruction 4t.

When obtaining the node weight update instruction 4t, the node 40a may perform validity verification on the node weight update instruction 4t according to an object public key of the object A₁ (i.e., the first public key) and the master signature information to obtain a validity verification result. The validity verification results here is determined by both a checking result and a master signature result.

For example, the node 40a needs to first perform signature verification on the master signature information based on the object public key of the object A₁ to obtain a master signature verification result. That is, the node 40a may obtain the object public key of the object A₁, and further perform signature verification on the master signature information based on the object public key of the object A₁ to obtain the first digest information of the node weight update instruction 4t. At the same time, the node 40a may also obtain a hash calculation rule the same as that of the terminal device 400Z and perform hash calculation on the node weight update instruction 4t to obtain digest information (e.g., digest information H) of the node weight update instruction 4t. In this embodiment, the digest information of the node weight update instruction 4t determined by the node 40a may be referred to as second digest information. Then, the node 40a may compare the first digest information with the second digest information to obtain a master signature verification result to determine whether the node weight update instruction 4t has been tampered with. If the first digest information is different from the second digest information, the node 40a may determine that the master signature verification result indicates failed verification. In some embodiments, if the first digest information is the same as the second digest information, the node 40a may determine that the master signature verification result indicates successful verification, which means that the node weight update instruction 4t has not been tampered and the node weight update instruction 4t is indeed transmitted by the terminal device 400Z.

At the same time, the node 40a also needs to check an instruction format of the node weight update instruction 4t based on a smart contract on the blockchain network to obtain a checking result. If the master signature verification result indicates successful verification and the checking result indicates successful checking, the node 40a may generate the validity verification result for indicating that the node weight update instruction 4t is valid. If the master signature verification result indicates failed verification or the checking result indicates failed checking, the node 40a may generate a validity verification result for indicating that the node weight update instruction 4t is not valid.

When the validity verification result indicates that the node weight update instruction 4t is not valid (i.e., failed verification), the node 40a may discard the node weight update instruction 4t. In some embodiments, when the validity verification result indicates that the node weight update instruction 4t is valid (i.e., successful verification), the node 40a needs to continue to perform multi-signature verification on the multi-party signature information based on second public keys respectively corresponding to second objects associated with M second service organizations to obtain a multi-signature verification result. The second public keys respectively corresponding to the second objects associated with the M second service organizations here may include an object public key of the object B₁, an object public key of the object B₂, an object public key of the object C₁, and an object public key of the object D₁. In this embodiment, a non-interactive aggregate signature rule (for example, Schnorr algorithm) may be used to perform multi-party signature on the node weight update instruction 4t to obtain the multi-party signature information, and for a specific implementation that the node 40a performs multi-party signature verification on the multi-party signature information, reference may be made to the non-interactive aggregate signature rule, which will not be described in detail.

When the multi-signature verification result indicates failed verification, the node 40a may discard the node weight update instruction 4t. In some embodiments, if the multi-signature verification result indicates successful verification, the node 40a may broadcast the node weight update instruction 4t to other nodes in the blockchain network, to wait for the master node having the proposal function to perform uploading. For example, if the master node is the node 40a, the node 40a may continue to perform operation S102 below. As can be seen, the validity verification and the multi-signature verification can ensure that the node weight update instruction to be executed subsequently is valid and reliable, and through the validity verification and the multi-signature verification, some abnormal or illegal node weight update instructions can be discarded, which avoids an incorrect node weight update. That is, by executing a valid and reliable node weight update instruction, an updated node weight can be ensured to be valid and reliable.

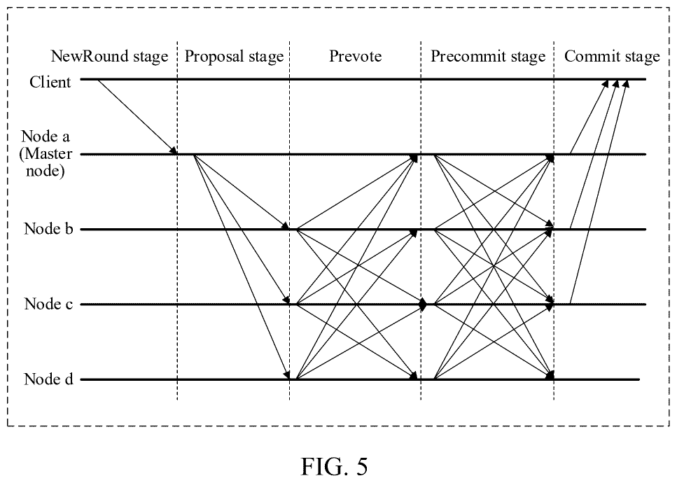

The blockchain network of this application may use an original consensus algorithm (for example, TBFT consensus). For ease of understanding, further, referring to FIG. 5, FIG. 5 is a schematic flowchart of a consensus algorithm according to an embodiment of this application. As shown in FIG. 5, a blockchain network in this embodiment may include N consensus nodes. The N consensus nodes may specifically include a master node having a proposal function (e.g., a node a) and (N−1) backup nodes having a verification function, which may specifically include a node b, a node c, and a node d. Here, N may be a positive integer equal to (3F+1), and F may be a maximum quantity of illegal nodes allowed by the blockchain network.

Under a TBFT consensus algorithm, a consensus procedure between nodes may include 5 stages, which may specifically include a NewRound stage, a Proposal stage, a Prevote stage, a Precommit stage, and a Commit stage of consensus voting.

In the NewRound stage, the node a initializes a consensus related state when receiving a transaction (e.g., a node weight update instruction generated for the node a) transmitted by a client in the first terminal device.

In the Proposal stage, the master node may generate a proposal and broadcast the proposal to the other nodes. For example, the node a packetizes a transaction to be uploaded, and broadcasts a block generated after the packetizing respectively to the node b, the node c, and the node d.

In the Prevote stage, for any backup node in the node b, the node c, and the node d, after receiving a block transmitted by the node a, the backup node may execute a transaction in the block and determine whether a block hash value of the block is correct, to generate prevote voting information (i.e., the first voting information) in the Prevote stage and broadcast the prevote voting information to the other nodes. If the block hash value is correct, the backup node generates prevote voting information for indicating a positive vote. Otherwise, the backup node generates prevote voting information for indicating a negative vote.

In the Precommit stage, any consensus node can collect prevote voting information generated by the other nodes in the Prevote stage, and if a quantity of votes in collected prevote voting information reaches (2F+1), this consensus node generates Precommit voting information (i.e., the second voting information) according to the collected prevote voting information and broadcasts the Precommit voting information to the other nodes.

In the Commit stage, any consensus node can collect Precommit voting information generated by the other nodes in the Precommit stage, and if a quantity of votes in the collected Precommit voting information reaches (2F+1), this consensus node generates a commit message according to the collected Precommit voting information. Here, the commit message is configured for indicating whether to commit the block in the proposal to a database.

Operation S102: Predict whether an updated node weight of the first consensus node meets a node update condition based on the node weight update instruction, to obtain a prediction result; and update the node weight of the first consensus node according to the node weight update instruction in response to the prediction result being positive, to obtain an update result.

The consensus algorithm (for example, TBFT consensus) mentioned above is a three-stage model. In this embodiment, a weight of voting information initiated by the first consensus node in a process of participating in the consensus service is changed based on an idea of the node weight. Therefore, for the sake of security, in this embodiment, the three-stage model and the whole fault tolerance mechanism are not modified, but two prediction rules are designed for the blockchain network. Both of the two prediction rules can be used to indicate whether an updated node weight for the first consensus node meets the node update condition. Specifically, the prediction rule may include the first prediction rule (for example, a strong rule) or the second prediction rule (for example, a weak rule). The strong rule means that after a consensus node updates its weight, even if an abnormality occurs in the consensus node subsequently, it cannot affect a normal consensus of the whole blockchain network. That is, in this case, the node update condition may be a condition that the updated node weight of the first consensus node does not affect the normal consensus of the blockchain network. The prediction result may be positive or negative. A positive result may indicate that a predicted updated node weight of the first consensus node meets the node update condition, and the positive result may also indicate that the updated node weight of the first consensus node does not affect the normal consensus of the blockchain network. A negative result may indicate that the predicted updated node weight of the first consensus node does not meet the node update condition, and the negative result may also indicate that the updated node weight of the first consensus node affects the normal consensus of the blockchain network.

For the weak rule, there is no control in a node weight update process, i.e., it can be directly determined that the updated node weight of the first consensus node meets the node update condition based on the node weight update instruction, but there will be strict requirements in the subsequent consensus stage. In this case, the node update condition may be a condition that the node weight of the first consensus node is allowed to be updated by default. The prediction result can only be positive. The positive result may indicate that the predicted updated node weight of the first consensus node meets the node update condition, and the positive result may also indicate that the node weight of the first consensus node is allowed to be updated. The prediction rule obtained by the target consensus node may be directly obtained from the database in the blockchain network (i.e., the blockchain network database, which may also refer to the blockchain ledger), or read from a smart contract associated with the blockchain network, or agreed on by the N consensus nodes in the blockchain network (e.g., read from a configuration file), which is not limited here.

The configuration weight of the first consensus node in the update result here is configured for indicating the weight of the voting information initiated by the first consensus node in the process of participating in the consensus service. If the prediction rule is the first prediction rule, the target consensus node (i.e., the master node) needs to determine whether the first consensus node meets the node update condition based on the configuration weight in the node weight update instruction and a node weight list corresponding to the blockchain network, to obtain the prediction result. The node update condition here may also mean that the configuration weight of the first consensus node is less than or equal to the maximum quantity of illegal nodes allowed in the blockchain network, to ensure that the updated node weight of the first consensus node (i.e., the configuration weight) does not affect the normal consensus of the blockchain network. If the prediction rule is the second prediction rule, the target consensus node may directly determine by default that the predicted updated node weight of the first consensus node meets the node update condition, i.e., the node weight update instruction may be directly executed to update the node weight of the first consensus node, to obtain the update result.

Each consensus node in the blockchain network has a corresponding node identifier, and each consensus node may have node identifiers of the other consensus nodes in the blockchain network stored therein, to broadcast a generated block to the other consensus nodes subsequently according to the node identifiers of the other consensus nodes. The node identifier may be an Internet protocol (IP, a protocol for interconnection between networks) address and any other information that can be configured for identifying the node.

In other words, each consensus node may maintain a node identifier list. Since this embodiment provides the processing model in which the nodes in the blockchain network support the weights themselves, in this embodiment, a field for indicating the node weight and a field for indicating the service organization corresponding to the consensus node may be newly added based on the node identifier list, to obtain the node weight list corresponding to the blockchain network.

For ease of understanding, further, referring to Table 1, Table 1 is a node weight list corresponding to a blockchain network according to an embodiment of this application. The node weight list may include a field corresponding to a service organization, a field corresponding to a name of a consensus node, a field corresponding to a node identifier, and a field corresponding to a node weight. Certainly, the node weight list may also be another list including the field corresponding to the node weight, which is not limited here. As shown in Table 1, the blockchain network corresponding to the node weight list may be the blockchain network in the embodiment corresponding to FIG. 1 above. The blockchain network may include 4 consensus nodes, which may specifically include a node 10a corresponding to a service organization A, a node 10b corresponding to a service organization B, a node 10c corresponding to a service organization C, and a node 10d corresponding to a service organization D. One consensus node corresponds to one consensus node weight. Details are shown in Table 1:

TABLE 1

| | Consensus | | |
|---|---|---|---|
| Service organization | node | Node identifier | Node weight |
| Service organization A | Node 10a | Node identifier Bₐ | Weight Wₐ |
| | | | (e.g., 1) |
| Service organization B | Node 10b | Node identifier B_{b} | Weight W_{b} |
| | | | (e.g., 1) |
| Service organization C | Node 10c | Node identifier B_{c} | Weight W_{c} |
| | | | (e.g., 1) |
| Service organization D | Node 10d | Node identifier B_{d} | Weight W_{d} |
| | | | (e.g., 1) |

For example, if the prediction rule is the first prediction rule, the target consensus node may obtain the node weight list corresponding to the blockchain network. Since the first consensus node here belongs to the N consensus nodes included in the blockchain network, in this embodiment, the node weight of each of the N consensus nodes in the node weight list may be referred to as the node weight. N is a positive integer. Then, the target consensus node may determine a maximum quantity F of illegal nodes allowed by the blockchain network based on the N node weights and the configuration weight carried by the node weight update instruction, and further compare the configuration weight with the maximum quantity F to obtain a comparison result.

When determining the maximum quantity F, the target consensus node may obtain (N−1) node weights other than the node weight of the first consensus node from the N node weights, and further sum the (N−1) node weights and a configuration weight carried by the node weight update instruction to obtain a predicted total node weight H corresponding to the blockchain network. Here, H is a positive integer. Further, the target consensus node may obtain a node configuration rule (i.e., H=3F+1) corresponding to the blockchain network and determine the maximum quantity F of the illegal nodes allowed by the blockchain network based on the total node weight H and the node configuration rule.

If the comparison result indicates that the configuration weight is less than or equal to the maximum quantity F, the target consensus node may determine that the configuration weight meets the node update condition, i.e., may determine that the prediction result is positive, and further may update the node weight of the first consensus node based on the configuration weight in the node weight update instruction, to obtain an update result. The configuration weight of the first consensus node in the update result here may be configured for updating the node weight list of the blockchain network. In some embodiments, if the comparison result indicates that the configuration weight is greater than the maximum quantity F, the target consensus node may determine that the prediction result is negative, and the prediction result being negative indicates that the configuration weight does not meet the node update condition, and discard the node weight update instruction. As can be seen, in this application, before the node weight is updated, the strong rule may be used to ensure that the configuration weight that is desired to be changed does not affect the normal consensus of the whole blockchain network, i.e., even if the consensus node that has been changed to the configuration weight becomes abnormal or malicious, the blockchain network can still normally complete the consensus process. A configuration weight that does not meet the node update condition (i.e., the configuration weight that is greater than the maximum quantity F of the illegal nodes allowed by the blockchain network) is not allowed to be changed. This can effectively improve the security of updating the node weight and ensure that the blockchain network after the node weight is updated can still perform the consensus procedure securely and normally.

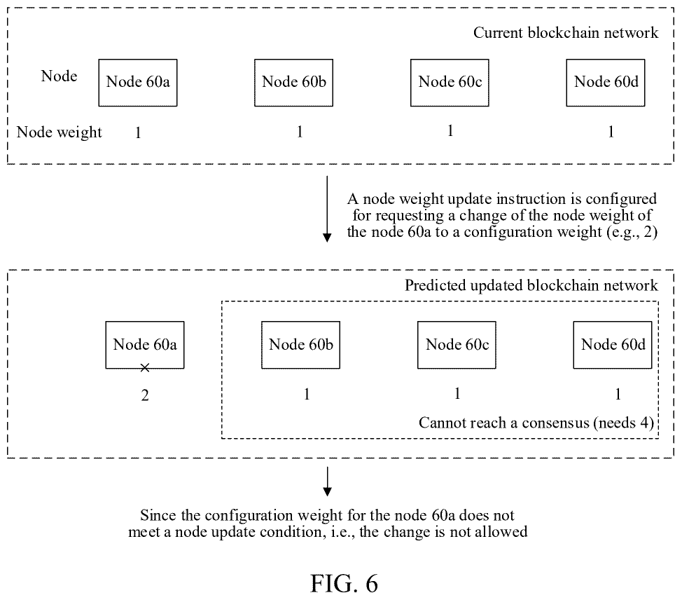

For ease of understanding, further, referring to FIG. 6, FIG. 6 is a schematic diagram I of a scenario of updating a node weight of the first consensus node according to an embodiment of this application. As shown in FIG. 6, a total quantity N of nodes in a blockchain network (i.e., a current blockchain network) in this embodiment may be 4, which may specifically include a node 60a, a node 60b, a node 60c, and a node 60d.

If a prediction rule is the first prediction rule, a target consensus node (i.e., a master node) may obtain a node weight list corresponding to the blockchain network. For example, the node weight list may include a node weight (e.g., 1) of the node 60a, a node weight (e.g., 1) of the node 60b, a node weight (e.g., 1) of the node 60c, and a node weight (e.g., 1) of the node 60d.

Since a node weight update instruction is configured for requesting a change of the node weight of the node 60a to a configuration weight (e.g., 2), the target consensus node needs to obtain 3 node weights other than the node weight of the node 60a from 4 node weights, and further may sum the 3 node weights and a configuration weight of the node 60a to obtain a predicted updated total node weight H (e.g., 5) corresponding to the blockchain network. Further, the target consensus node may determine the maximum quantity F (e.g., 1) of illegal nodes allowed by the blockchain network based on a node configuration rule corresponding to the blockchain network.

A node update condition in the first prediction rule indicates that once the node after the update exits, it is required to ensure that the other nodes can still reach agreement. Therefore, after predicting an update of the node weight of the node 60a, the blockchain network after predicting the update needs 4 consensus-reached consensus results before a consensus is reached. If the node 60a becomes abnormal (e.g., in an abnormal state such as being offline or malicious), the remaining node 60b, node 60c, and node 60d cannot reach a consensus, which means that the first prediction rule does not allow the node 60a to change the node weight. In other words, since the configuration weight of the node 60a is greater than the maximum quantity F, the target consensus node may determine that the configuration weight for the node 60a does not meet the node update condition and directly discard the node weight update instruction.

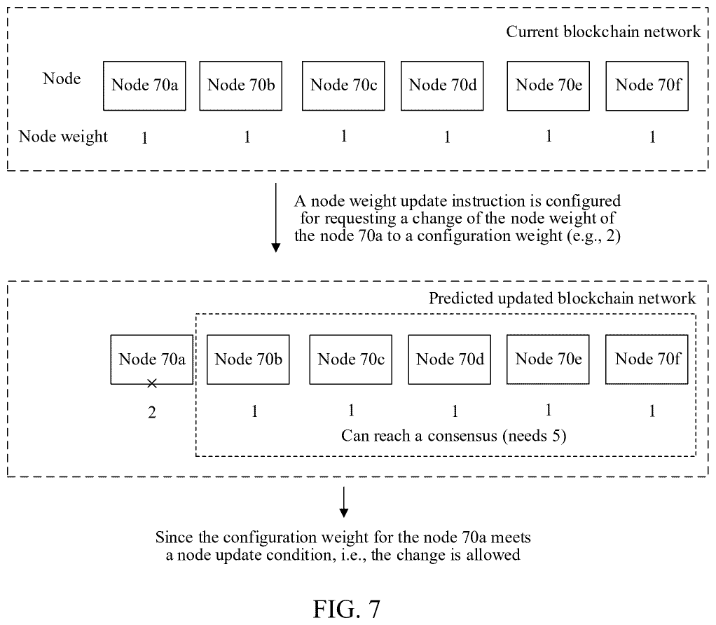

For ease of understanding, further, referring to FIG. 7, FIG. 7 is a schematic diagram II of a scenario of updating a node weight of the first consensus node according to an embodiment of this application. As shown in FIG. 7, a total quantity N of nodes in a blockchain network (i.e., a current blockchain network) in this embodiment may be 6, which may specifically include a node 70a, a node 70b, a node 70c, a node 70d, a node 70e, and a node 70f.

If a prediction rule is the first prediction rule, a target consensus node (i.e., a master node) may obtain a node weight list corresponding to the blockchain network. For example, the node weight list may include a node weight (e.g., 1) of the node 70a, a node weight (e.g., 1) of the node 70b, a node weight (e.g., 1) of the node 70c, a node weight (e.g., 1) of the node 70d, a node weight (e.g., 1) of the node 70e, and a node weight (e.g., 1) of the node 70f.

Since a node weight update instruction is configured for requesting a change of the node weight of the node 70a to a configuration weight (e.g., 2), the target consensus node needs to obtain 5 node weights other than the node weight of the node 70a from 6 node weights, and further may sum the 5 node weights and the configuration weight of the node 70a to obtain a predicted updated total node weight H (e.g., 7) corresponding to the blockchain network. Further, the target consensus node may determine the maximum quantity F (e.g., 2) of illegal nodes allowed by the blockchain network based on a node configuration rule corresponding to the blockchain network.

The node update condition in the first prediction rule indicates that once the node after the update exits, it is required to ensure that the other nodes can still reach agreement. Therefore, after predicting an update of the node weight of the node 70a, the blockchain network after predicting the update needs 5 consensus-reached consensus results before a consensus can be reached. If the node 70a becomes abnormal (e.g., in an abnormal state such as being offline or malicious), the remaining node 70b, node 70c, node 70d, node 70e, and node 70f can still reach a consensus, which means that the first prediction rule allows the node 70a to change the node weight. In other words, since the configuration weight of the node 70a is equal to the maximum quantity F, the target consensus node may determine that the configuration weight for the node 70a meets the node update condition and further update the node weight of the node 70a based on the configuration weight, to obtain an update result. The node weight (i.e., the configuration weight) of the node 70a in the update result may be configured for updating the node weight list of the blockchain network. Updating the node weight list of the blockchain network can ensure that a correct node weight of each consensus node currently can be recorded in time, so that when the node weight is updated next time, an accurate node weight can be obtained through an updated node weight list, thereby ensuring that the node weight update can continue to be completed securely and reliably.

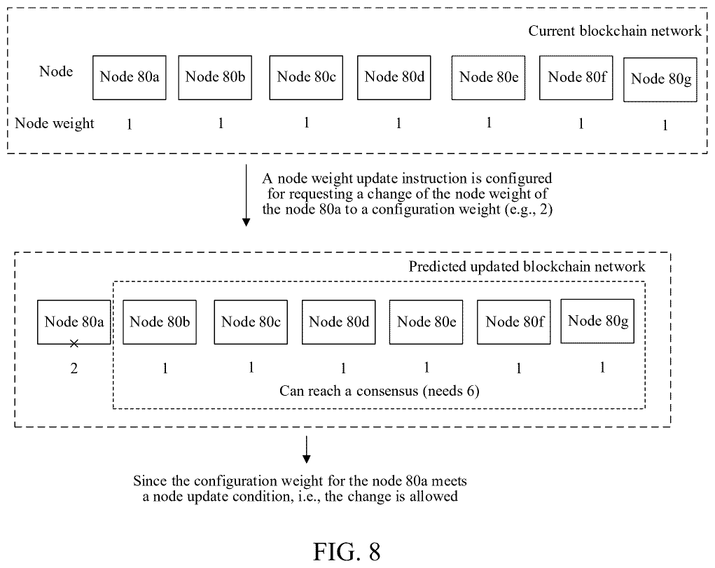

For ease of understanding, further, referring to FIG. 8, FIG. 8 is a schematic diagram III of a scenario of updating a node weight of the first consensus node according to an embodiment of this application. As shown in FIG. 8, a total quantity N of nodes in a blockchain network (i.e., a current blockchain network) in this embodiment may be 7, which may specifically include a node 80a, a node 80b, a node 80c, a node 80d, a node 80e, a node 80f, and a node 80g.

If a prediction rule is the first prediction rule, a target consensus node (i.e., a master node) may obtain a node weight list corresponding to the blockchain network. For example, the node weight list may include a node weight (e.g., 1) of the node 80a, a node weight (e.g., 1) of the node 80b, a node weight (e.g., 1) of the node 80c, a node weight (e.g., 1) of the node 80d, a node weight (e.g., 1) of the node 80e, a node weight (e.g., 1) of the node 80f, and a node weight (e.g., 1) of the node 80g.

Since a node weight update instruction is configured for requesting a change of the node weight of the node 80a to a configuration weight (e.g., 2), the target consensus node needs to obtain 6 node weights other than the node weight of the node 80a from 7 node weights, and further may sum the 6 node weights and the configuration weight of the node 80a to obtain a predicted updated total node weight H (e.g., 8) corresponding to the blockchain network. Further, the target consensus node may determine the maximum quantity F (e.g., 2) of illegal nodes allowed by the blockchain network based on a node configuration rule corresponding to the blockchain network.

A node update condition in the first prediction rule indicates that once the node after the update exits, it is required to ensure that the other nodes can still reach agreement. Therefore, after predicting an update of the node weight of the node 80a, the blockchain network after predicting the update needs 6 consensus-reached consensus results before a consensus can be reached. If the node 80a becomes abnormal (e.g., in an abnormal state such as being offline or malicious), the remaining node 80b, node 80c, node 80d, node 80e, node 80f, and node 80g can still reach a consensus, which means that the first prediction rule allows the node 80a to change the node weight. In other words, since the configuration weight of the node 80a is equal to the maximum quantity F, the target consensus node may determine that the configuration weight for the node 80a meets the node update condition and further update the node weight of the node 80a based on the configuration weight, to obtain an update result. The node weight (i.e., the configuration weight) of the node 80a in the update result may be configured for updating the node weight list of the blockchain network.

For another example, if the prediction rule is the second prediction rule, the target consensus node may directly obtain a configuration weight carried by the node weight update instruction, and determine by default that the prediction result is positive according to the node weight update instruction, and the prediction result being positive indicates that the configuration weight meets the node update condition, to further obtain the node weight of the first consensus node from the blockchain network in response to the prediction result being positive and change the node weight of the first consensus node to the configuration weight, to obtain the update result. As can be seen, in this application, by providing a node weight update mechanism based on a weak rule, the node weight update can be completed more efficiently when the user has a timeliness requirement.

Operation S103: Record the update result in a database of the blockchain network.

Specifically, when the target consensus node is the master node having the proposal function in the blockchain network, the blockchain network further includes (N−1) backup nodes. The blockchain network includes N consensus nodes, and the (N−1) backup nodes refer to consensus nodes other than the target consensus node in the N consensus nodes. N is the total quantity of the consensus nodes in the blockchain network. N is a positive integer equal to (3F+1). F is the maximum quantity of the illegal nodes allowed by the blockchain network. In this case, the target consensus node may packetize the update result (in some embodiments, the target consensus node may packetize the update result and the node weight update instruction together) to obtain a to-be-verified block to be written into the blockchain network. Then, the target consensus node may broadcast the to-be-verified block to the (N−1) backup nodes in the blockchain network such that the (N−1) backup nodes perform a consensus on an obtained to-be-verified block, to obtain a consensus result. Further, the target consensus node may count consensus-reached consensus results (the consensus-reached consensus results may be interpreted as consensus results of positive vote in consensus voting) from received consensus results and determine counted consensus-reached consensus results as a consensus result set, and further may determine a sum of node weights of the backup nodes corresponding to each consensus result in the consensus result set as a consensus quantity corresponding to the consensus result set. If a ratio of a consensus quantity to the total node weight corresponding to the blockchain network reaches a consensus threshold, it is determined that the consensus nodes in the blockchain network reach a consensus, and further, the to-be-verified block is written as a target block into the database of the blockchain network. The total node weight refers to a sum of the node weights of the N consensus nodes. The target block written into the database of the blockchain network is configured for indicating that an updated node weight of the first consensus node is capable of weighing the voting information of the first consensus node in a consensus service.

This embodiment provides a processing model in which the nodes in the blockchain network support the weights themselves. Therefore, in this embodiment, the node weights of the consensus nodes may be stored in the newest block (e.g., the update result in a block or a state tree in the block) in the blockchain network, or in a node weight list maintained by themselves, or in a configuration file associated with the consensus nodes. Certainly, a current node weight here may also be stored in other forms, and examples are not provided herein.

For example, if the node weights of the consensus nodes are to be stored in the update result of the newest block in the blockchain network, after performing operation S102, the target consensus node may obtain a block having a largest generation timestamp from the blockchain network and determine information to be packetized based on a block hash value of an obtained block and an update result of the block, and further, may packetize the information to be packetized and take a packetized block as the to-be-verified block to be written into the blockchain network. Then, the target consensus node may broadcast the to-be-verified block to the (N−1) backup nodes in the blockchain network such that the (N−1) backup nodes perform a consensus on an obtained to-be-verified block, to obtain a consensus result. When it is determined that the consensus nodes in the blockchain network reach a consensus for the to-be-verified block, the to-be-verified block may be written as a target block into the blockchain network. The generation timestamp of the target block here may be configured for updating the largest generation timestamp of the blockchain network.

For another example, if the node weights of the consensus nodes are to be stored in the state tree of the newest block in the blockchain network, it means that each block in the blockchain network can store the state tree associated with the node weights of the N consensus nodes. Therefore, after performing operation S102, the target consensus node may obtain a block having the largest generation timestamp from the blockchain network, and further may take an obtained block as a parent block. A state tree in the parent block has the node weight of the first consensus node stored therein. Further, the target consensus node may obtain a leaf node for storing the node weight of the first consensus node from the state tree of the parent block based on a path indicated by key information (e.g., the node identifier) of the first consensus node, and then change stored information of an obtained leaf node from the node weight of the first consensus node to the configuration weight carried by the node weight update instruction, to obtain an updated state tree. Then, the target consensus node may determine the information to be packetized based on the block hash value of the parent block, the updated state tree, and the update result, and further may packetize the information to be packetized and take the packetized block as the to-be-verified block to be written into the blockchain network. Then, the target consensus node may broadcast the to-be-verified block to the (N−1) backup nodes in the blockchain network such that the (N−1) backup nodes perform a consensus on an obtained to-be-verified block, to obtain a consensus result. When it is determined that the consensus nodes in the blockchain network reach a consensus for the to-be-verified block, the to-be-verified block may be written as a target block into the blockchain network. The generation timestamp of the target block here may be configured for updating the largest generation timestamp of the blockchain network, and the node weight of the first consensus node stored in the state tree of the target block is the configuration weight of the first consensus node.

For another example, if the node weights of the consensus nodes are to be stored in the node weight list maintained by themselves, after the target consensus node performs operation S103, i.e., after the target consensus node writes the target block into the blockchain network, the target consensus node may further search the node weight of the first consensus node from the node weight list (e.g., the node weight list shown in Table 1 above) corresponding to the blockchain network, and further change a searched node weight to the configuration weight in the node weight list.

For another example, if the node weights of the consensus nodes are to be stored in the configuration file of the consensus nodes, after the target consensus node performs operation S103, i.e., after the target consensus node writes the target block into the blockchain network, the target consensus node may change the node weight of the first consensus node in the configuration file to the configuration weight.

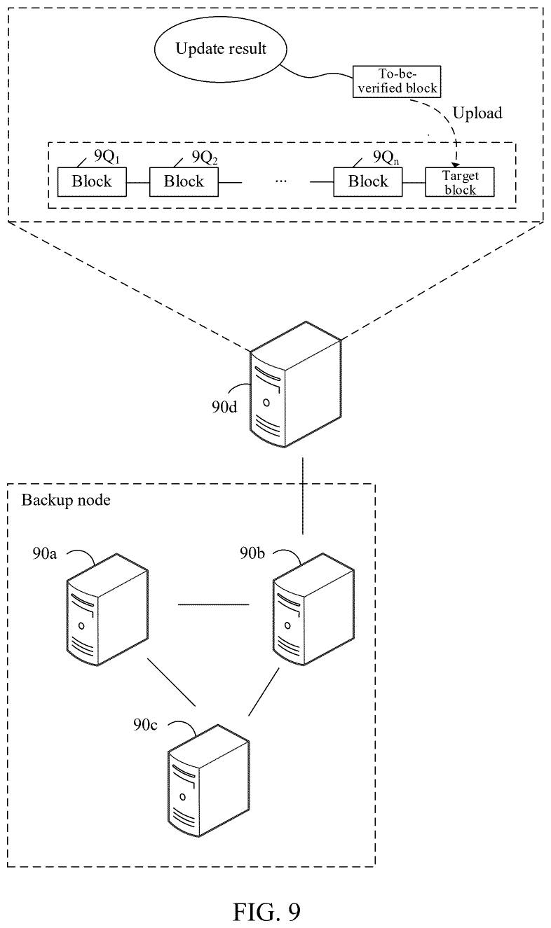

For ease of understanding, further, referring to FIG. 9, FIG. 9 is a schematic diagram of a scenario of transaction uploading according to an embodiment of this application. As shown in FIG. 9, in this embodiment, a total quantity of consensus nodes in a blockchain network may be 4, which may specifically include a node 90a, a node 90b, a node 90c, and a node 90d. The node 90d may be a master node having a proposal function determined according to a block producing rule associated with the blockchain network, and the node 90a, the node 90b, and the node 90c may all be referred to as backup nodes.

The node weight update instruction here may be configured for requesting a change of a node weight of the node 90a to a configuration weight (e.g., 2). The blockchain network shown in FIG. 9 may be the same blockchain network shared by all the consensus nodes in the blockchain network, and each consensus node may obtain information (e.g., a current node weight of any consensus node) stored in the blockchain network from the blockchain network. Before the node 90d uploads an update result, the blockchain network includes a block 9Q₁, a block 9Q₂, . . . , and a block 9Qₙ.

Before uploading the update result, the node 90d (i.e., a target consensus node) needs to obtain a block having the largest generation timestamp (e.g., the block 9Qₙ shown in FIG. 9) from the blockchain network, and take a block hash value of the block 9Qₙ as a parent block hash value of a block to be generated. Further, the node 90d may packetize the parent block hash value and the update result and take a packetized block as a to-be-verified block to be written into the blockchain network to which the node 90d belongs.

In this case, the node 90d may broadcast the to-be-verified block to 3 backup nodes in the blockchain network in which the node 90d is located, such that the 3 backup nodes respectively perform a consensus on an obtained to-be-verified block, to obtain consensus results to be returned to the node 90d. A quota of the consensus result returned by each backup node is equal to the consensus quantity consistent with the node weight. For example, if the node weight of the node 90a is 1, a node weight of the node 90b is 1, a node weight of the node 90c is 3, and a node weight of the node 90d is 2, a total node weight of the blockchain network is 7. In this case, the quota of the consensus result returned by the node 90a is equivalent to one consensus result, the quota of the consensus result returned by the node 90b is equivalent to one consensus result, the quota of the consensus result returned by the node 90c is equivalent to three consensus results, and the quota of the consensus result returned by the node 90d is equivalent to two consensus results.

Then, the node 90d may count consensus-reached consensus results (the consensus-reached consensus results may be interpreted as consensus results of positive vote in consensus voting) from received consensus results and refer to counted consensus-reached consensus results as a consensus result set, and further may determine a sum of node weights of the backup nodes corresponding to each consensus result in the consensus result set as a consensus quantity corresponding to the consensus result set. If a ratio of the consensus quantity to the total node weight corresponding to the blockchain network reaches a consensus threshold (e.g., ⅔), it is determined that the consensus nodes in the blockchain network reach a consensus, and further, the to-be-verified block may be successfully written as a target block into a database of the blockchain network to serve as a next block of the block 9Qₙ, thereby effectively ensuring the data security of the update result on the chain. The generation timestamp of the target block is configured for updating the largest generation timestamp of the blockchain network.

Further, if the consensus nodes in the blockchain network do not reach a consensus and a prediction rule associated with the blockchain network is the second prediction rule (i.e., a prediction result is determined by default to be positive based on the node weight update instruction), the target consensus node may detect the consensus node in an abnormal state in the blockchain network and determine a detected consensus node as the second consensus node. Further, the target consensus node may obtain a node weight of the second consensus node. If the node weight of the second consensus node is greater than the maximum quantity F of illegal nodes allowed by the blockchain network, the second consensus node may be restarted, and a consensus state of the second consensus node may be updated. If an updated consensus state of the second consensus node is restored to a normal state, a consensus may be performed on the obtained to-be-verified block again. If the updated consensus state of the second consensus node is still the abnormal state, the target consensus node may generate alarm information associated with the second consensus node, and transmit the alarm information to a management terminal device associated with the blockchain network, such that a management object corresponding to the management terminal device processes the second consensus node. As can be seen, in this application, in the scenario of implementing a node weight update based on the weak rule, timeliness when the node weight is updated is considered, and an abnormality check mechanism is further set in a consensus process after the node weight is updated. That is, by restarting the consensus node with a node weight greater than the maximum quantity F of the illegal nodes allowed by the blockchain network, the consensus nodes affecting a consensus procedure of the blockchain network are recovered or warned in time. Therefore, the security of implementing the weak rule can be improved.

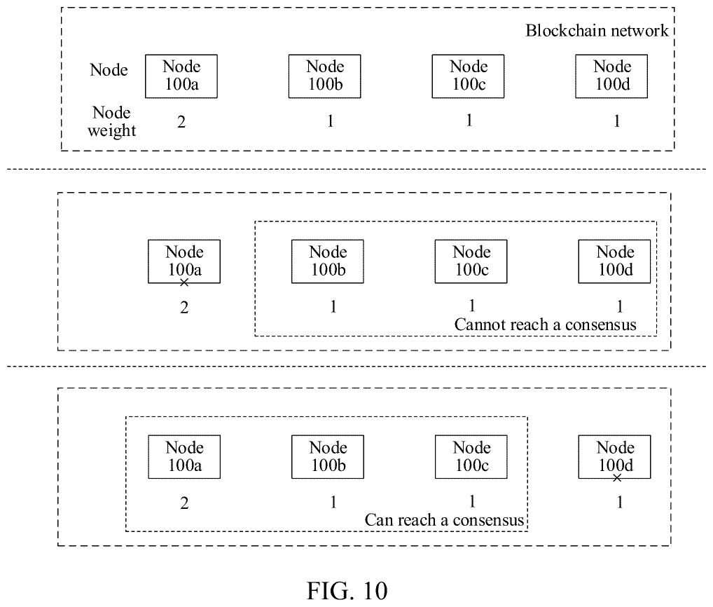

For ease of understanding, further, referring to FIG. 10, FIG. 10 is a schematic diagram of a scenario of a service consensus according to an embodiment of this application. As shown in FIG. 10, in this embodiment, a prediction rule associated with a blockchain network is the second prediction rule, and a total quantity of nodes in the blockchain network is 4, which may specifically include a node 100a, a node 100b, a node 100c, and a node 100d. For example, a node weight of the node 100a may be 2, a node weight of the node 100b may be 1, a node weight of the node 100c may be 1, and a node weight of the node 100d may be 1. In this case, the total node weight of the blockchain network is 5, and the maximum quantity of illegal node allowed by the blockchain network is 1.

If the node 100a is in an abnormal state, since the node weight of the node 100a is greater than the maximum quantity of the illegal nodes allowed by the blockchain network, the remaining nodes in the blockchain network cannot reach a consensus. In some embodiments, if only the node 100d is in the abnormal state, since the node weight of the node 100a is equal to the maximum quantity of the illegal nodes allowed by the blockchain network, the blockchain network can still reach a consensus.

Based on this, when a target consensus node uploads a to-be-verified block, if the consensus nodes in the blockchain network do not reach a consensus, the target consensus node needs to detect the consensus node in the abnormal state in the blockchain network and determine a detected consensus node as the second consensus node (e.g., the node 100a). Since the node weight of the node 100a is greater than the maximum quantity F of the illegal node allowed by the blockchain network, in this embodiment, the target consensus node may instruct the node 100a to restart to update a consensus state of the node 100a. If an updated consensus state of the node 100a is restored to a normal state, a consensus may be performed on an obtained to-be-verified block again.

In some embodiments, if the updated consensus state of the node 100a is the abnormal state, the target consensus node may generate alarm information associated with the node 100a and transmit the alarm information to a management terminal device associated with the blockchain network, such that a management object corresponding to the management terminal device processes the node 100a. The alarm information here may be in the form of voice, text, video, picture, or other type of alarm information, which is not limited here.

In this embodiment, if the first service organization wants to have greater decision-making power in the whole blockchain network, there is no need to increase a quantity of nodes of the first service organization. Instead, based on an idea of the node weight, the node weight of the first consensus node is changed to change the weight of voting information initiated by the first consensus node in a process of participating in the consensus service. A deployment mode of changing the node weight in this application does not need to add a new consensus node, so there is no need to perform various configuration operations required for creating the new consensus node, which can reduce a workload of node deployment. Moreover, since the quantity of consensus nodes in the blockchain network is not increased, resource consumption of the blockchain network will not be additionally increased. In addition, since the quantity of consensus nodes maintained and managed is not increased, a difficulty in maintaining and managing the consensus nodes will not be increased.

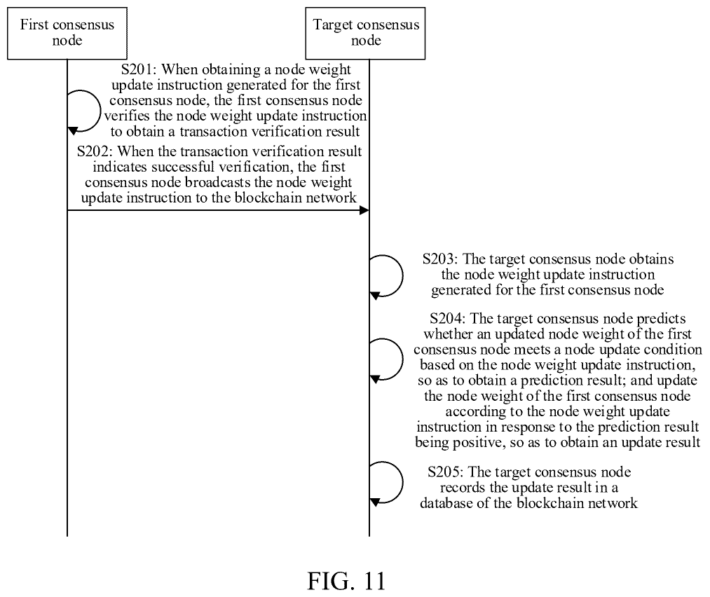

Further, referring to FIG. 11, FIG. 11 is a schematic flowchart of a data processing method based on a blockchain according to an embodiment of this application. The method involves a target consensus node (i.e., a master node having a proposal function) and the first consensus node in a blockchain network. The target consensus node here is not the first consensus node, but another consensus node (e.g., the third consensus node) other than the first consensus node in the blockchain network. This method may include at least the following operations S201 to S205:

Operation S201: When obtaining a node weight update instruction generated for the first consensus node, the first consensus node verifies the node weight update instruction to obtain a transaction verification result.

The transaction verification result is determined by the first consensus node based on a validity verification result and a multi-signature verification result. The validity verification result is generated by the first consensus node after performing validity verification on the node weight update instruction. The multi-signature verification result is obtained by the first consensus node after performing multi-signature verification on multi-party signature information carried in the node weight update instruction when determining that the validity verification result indicates that the node weight update instruction is valid.

Operation S202: When the transaction verification result indicates successful verification, the first consensus node broadcasts the node weight update instruction to a blockchain network.

Specifically, when the transaction verification result indicates successful verification, the first consensus node may broadcast the node weight update instruction respectively to other consensus nodes (e.g., the third consensus nodes) other than the first consensus node in the blockchain network.

Operation S203: The target consensus node obtains the node weight update instruction generated for the first consensus node.

Operation S204: The target consensus node predicts whether an updated node weight of the first consensus node meets a node update condition based on the node weight update instruction, to obtain a prediction result; and update the node weight of the first consensus node according to the node weight update instruction in response to the prediction result being positive, to obtain an update result.

Operation S205: The target consensus node records the update result in a database of the blockchain network.

For specific implementations of operations S201 to S205, reference may be made to the description of operations S101 to S103 in the embodiment corresponding to FIG. 3 above. Details are not described herein again.

Further, when the target consensus node is the master node having the proposal function in the blockchain network and a block of the update result in the blockchain network is a target block (e.g., the target block shown in FIG. 9), the target consensus node may obtain a block producing rule associated with the blockchain network. The block producing rule here may be a block producing rule associated with the node weight (i.e., the first block producing rule) or a block producing rule not associated with the node weight (i.e., the second block producing rule). If the block producing rule is the block producing rule associated with the node weight, the target consensus node may obtain the node weight of the target consensus node. The node weight of the target consensus node here is configured for indicating a total quantity of times of block production of the target consensus node in a current round.

If a quantity of times of block production of the target consensus node in the current round does not reach the total quantity of times of block production, the target consensus node may continue to determine the target consensus node as the master node having the proposal function such that the target consensus node continues to upload a next block of the target block. Every time the target consensus node uploads a block, it accumulates the quantity of times of block production. In some embodiments, if the quantity of times of block production of the target consensus node in the current round reach the total quantity of times of block production, in this embodiment, the next node of the target consensus node determined based on the block producing rule may be determined as the master node having the proposal function, such that the new master node uploads the next block of the target block. As can be seen, in this application, the node weight can not only act on a consensus voting process, but also determine polling timing of the master node. That is, a consensus node with a higher node weight may have more opportunities to become the master node, thereby further improving the influence of the node weight.

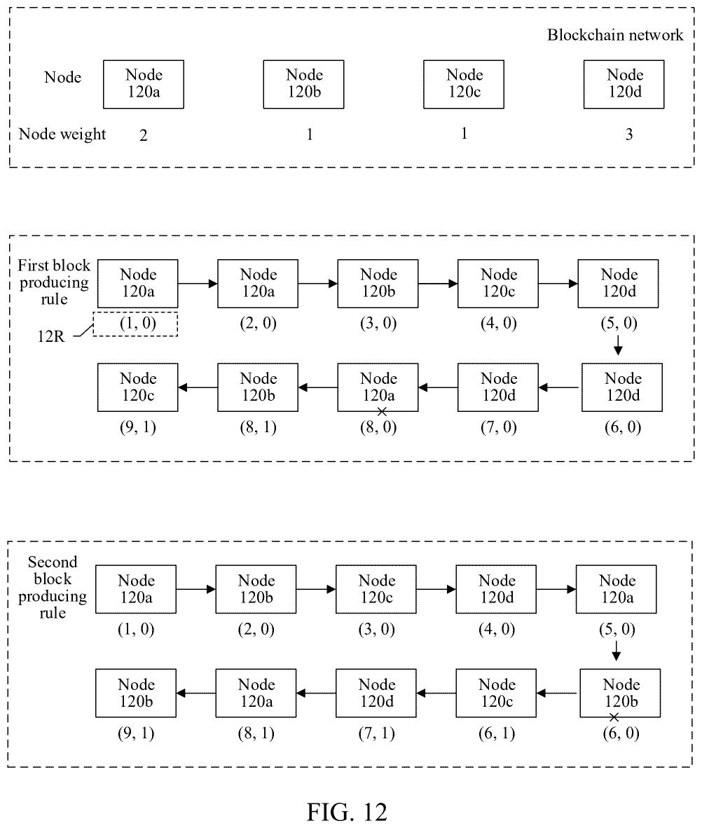

For ease of understanding, further, referring to FIG. 12, FIG. 12 is a schematic diagram of a scenario of taking turns to serve as a master node according to an embodiment of this application. As shown in FIG. 12, in this embodiment, a total quantity of consensus nodes in a blockchain network may be 4, which may specifically include a node 120a, a node 120b, a node 120c, and a node 120d. For example, a node weight of the node 120a may be 2, a node weight of the node 120b may be 1, a node weight of the node 120c may be 1, and a node weight of the node 120d may be 3.

If a block producing rule associated with the blockchain network is the first block producing rule (i.e., the block producing rule associated with the node weight), a node weight of each consensus node is configured to indicate a total quantity of times of block production of the node in the current round. A polling sequence of a master node in the blockchain network in a certain round may be the node 120a, the node 120a (i.e., the node 120a may continuously serve as the master node twice, i.e., may continuously upload two blocks), the node 120b, the node 120c, the node 120d, the node 120d, and the node 120d (i.e., the node 120d may continuously serve as the master node 3 times, i.e., may continuously upload 3 blocks). The first parameter included in parameters 12R shown in FIG. 12 is 1, which is configured for indicating that a block height of a new block generated by a current master node (i.e., the node 120a) is 1, and the second parameter in the parameters 12R is 0, which is configured for indicating that the current round is the first round.

Taking the node 120d as an example, after the node 120d uploads the 5th block, the quantity of times of block production in the current round is one, since the node weight of the node 120d is 3, it means that the quantity of times of block production of the node 120d in the first round has not reached the total quantity of times of block production. In this case, the node 120d may continue to serve as the master node to upload the next block of the 5th block (i.e., the 6th block). After successfully uploading the 7th block, the quantity of times of block production of the node 120d in the current round is three, which is equal to the corresponding total quantity of times of block production. Therefore, in this case, another node will serve as the master node (e.g., the node 120a).

As shown in FIG. 12, when the node 120a is in an abnormal state when uploading the 8th block, in the block producing rule in this embodiment, the next node of the node 120a (e.g., the node 120b) may be determined as the master node according to a round sequence associated with the first block producing rule, such that the node 120b continues to upload the 8th block.

If the block producing rule associated with the blockchain network is the second block producing rule (i.e., the block producing rule not associated with the node weight), then the quantity of times of block production of each consensus node in the current round is 1. The polling sequence of the master node in the blockchain network in a certain round may be the node 120a, the node 120b, the node 120c, and the node 120d.

As shown in FIG. 12, when the node 120a is in an abnormal state when uploading the 6th block, in the block producing rule in this embodiment, the next node of the node 120b (e.g., the node 120c) may be determined as the master node according to a round sequence associated with the second block producing rule, such that the node 120c continues to upload the 6th block.

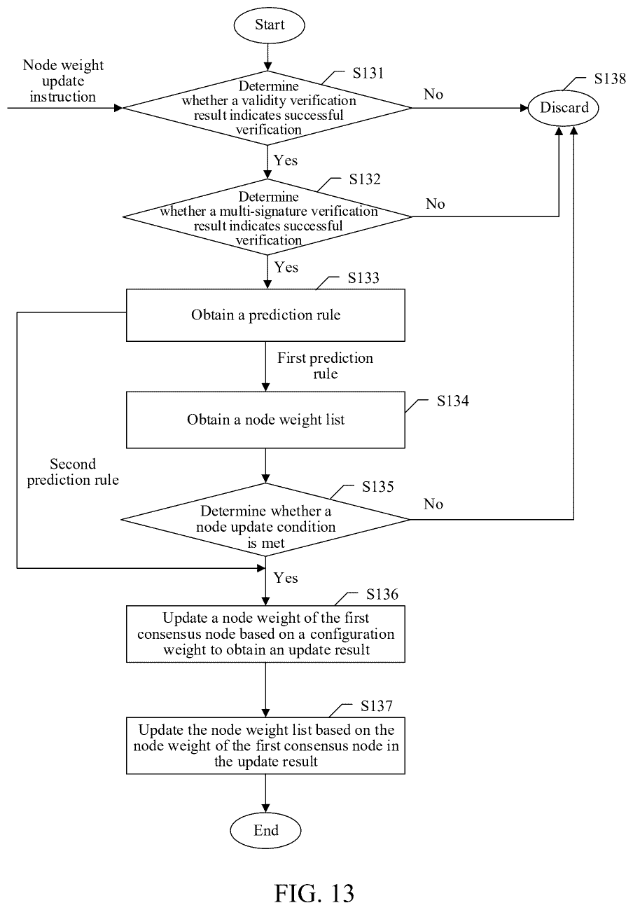

Further, referring to FIG. 13, FIG. 13 is a schematic flowchart of a data processing method based on a blockchain according to an embodiment of this application. The method may be performed by a target consensus node in a blockchain network. The target consensus node here is the first consensus node of a node weight to be configured, and is also a master node having a proposal function in the blockchain network.

As shown in FIG. 13, when the target consensus node receives a node weight update instruction generated for the first consensus node, the target consensus node may perform validity verification on the node weight update instruction (i.e., verify the master signature information carried by the node weight update instruction and an instruction format respectively) to obtain a validity verification result, and further may perform operation S131 to determine whether the validity verification result indicates successful verification. If the validity verification result indicates failed verification (i.e., the node weight update instruction is not valid), the target consensus node may perform operation S138 to discard the node weight update instruction.

If the validity verification result indicates successful verification (i.e., the node weight update instruction is valid), the target consensus node may continue to perform multi-signature verification on multi-party signature information carried by the node weight update instruction to obtain a multi-signature verification result, and further may perform operation S132 to determine whether the multi-signature verification result indicates successful verification. If the multi-signature verification result indicates failed verification, the target consensus node may perform operation S138 to discard the node weight update instruction.

If the multi-signature verification result indicates successful verification, the target consensus node may broadcast the node weight update instruction to the other nodes in the blockchain network. Then, when the target consensus node is the master node in the blockchain network, the target consensus node may continue to perform operation S133 to obtain a prediction rule associated with the blockchain network.

If the prediction rule is the first prediction rule, the target consensus node may perform operations S134 to S136. That is, the target consensus node may perform operation S134 to obtain a node weight list corresponding to the blockchain network, and further may perform operation S135 based on a configuration weight of the first consensus node in the node weight update instruction and the node weight list to determine whether the configuration weight meets a node update condition. If the configuration weight does not meet the node update condition, the target consensus node may perform operation S138 to discard the node weight update instruction. If the configuration weight meets the node update condition, the target consensus node may continue to perform operation S136, i.e., update the node weight of the first consensus node based on the configuration weight, to obtain an update result.

In some embodiments, if the prediction rule is the second prediction rule, the target consensus node may determine by default that the configuration weight meets the node update condition, i.e., may directly perform operation S136 to update the node weight of the first consensus node based on the configuration weight, to obtain the update result. Then, the target consensus node may write the update result into a database in the blockchain network when the consensus nodes in the blockchain network reach a consensus.

Further, the target consensus node may further perform operation S137 to update the node weight list based on the configuration weight of the first consensus node in the update result, to obtain an updated node weight list. At the same time, the target consensus node may further update a maximum quantity of illegal nodes allowed by the blockchain network based on the configuration weight of the first consensus node in the update result, to obtain an updated maximum quantity F.

In this embodiment, a new node deployment mode may be provided for the existing solution in which the blockchain network node needs to implement a weight by deploying more consensus nodes, and a processing model in which the consensus nodes support the weights themselves is provided based on an idea of the weight. In addition, on the one hand, the model supports both strong and weak prediction rules such that a user can choose according to an actual service scenario of the user to improve the service adaptability. On the other hand, in terms of security, the model can still meet the 3F+1 rule, and does not cause a reduction in security due to the node weight. The deployment mode of changing the node weight in this application does not need to add a new consensus node, so there is no need to perform various configuration operations required for creating the new consensus node, which can reduce a workload of node deployment. Moreover, since the quantity of consensus nodes in the blockchain network is not increased, resource consumption of the blockchain network will not be increased. In addition, since the quantity of consensus nodes maintained and managed is not increased, the difficulty level in maintaining and managing the consensus nodes will not be increased.

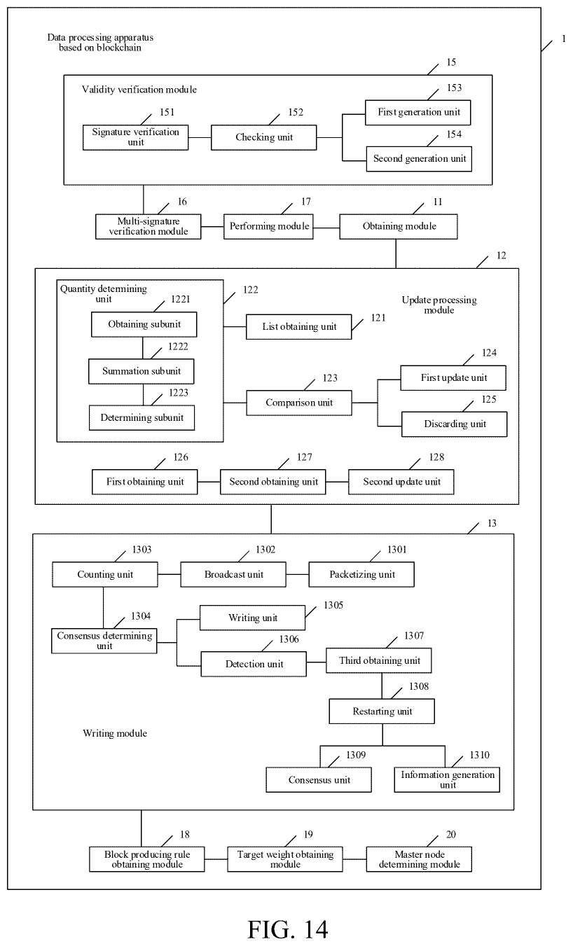

Further, referring to FIG. 14, FIG. 14 is a schematic structural diagram of a data processing apparatus based on a blockchain. As shown in FIG. 14, the data processing apparatus 1 based on a blockchain network may be a computer program (including program code) running in a network device. For example, the data processing apparatus 1 based on the blockchain network is application software. The data processing apparatus 1 based on a blockchain network may be configured to perform corresponding operations in the method provided in the embodiments of this application. As shown in FIG. 14, the data processing apparatus 1 based on a blockchain network may run in a target consensus node. The target consensus node may be any consensus node in the blockchain network in the embodiment corresponding to FIG. 1 above. The data processing apparatus 1 based on a blockchain network may include: an obtaining module 11, an update processing module 12, a writing module 13, a validity verification module 15, a multi-signature verification module 16, a performing module 17, a block producing rule obtaining module 18, a target weight obtaining module 19, and a master node determining module 20.

The obtaining module 11 is configured to obtain a node weight update instruction generated for the first consensus node in a blockchain network. The node weight update instruction is configured for instructing an update of a node weight configured for voting information of the first consensus node in a consensus service.

The update processing module 12 is configured to predict whether an updated node weight of the first consensus node meets a node update condition based on the node weight update instruction, to obtain a prediction result.

The update processing module 12 is further configured to update the node weight of the first consensus node according to the node weight update instructions in response to the prediction result being positive, to obtain an update result.

The first consensus node belongs to N consensus nodes included in the blockchain network. N is a positive integer.

The update processing module 12 includes: a list obtaining unit 121, a quantity determining unit 122, a comparison unit 123, the first update unit 124, a discarding unit 125, the first obtaining unit 126, the second obtaining unit 127, and the second update unit 128.

The list obtaining unit 121 is configured to obtain a node weight list corresponding to the blockchain network based on the node weight update instruction. The node weight list includes a node weight respectively corresponding to each of the N consensus nodes.

The quantity determining unit 122 is configured to determine a maximum quantity F of illegal nodes allowed by the blockchain network based on the N node weights and a configuration weight carried by the node weight update instruction. The configuration weight is a predicted updated node weight of the first consensus node.

The quantity determining unit 122 includes: an obtaining subunit 1221, a summation subunit 1222, and a determining subunit 1223.

The obtaining subunit 1221 is configured to obtain (N−1) node weights other than the node weight of the first consensus node from the N node weights.

The summation subunit 1222 is configured to sum the (N−1) node weights and the configuration weight carried by the node weight update instruction to obtain a total node weight H corresponding to the blockchain network. His a positive integer.

The determining subunit 1223 is configured to determine the maximum quantity F of the illegal nodes allowed by the blockchain network based on the total node weight H and a node configuration rule corresponding to the blockchain network. The node configuration rule is H=3F+1. H is the total node weight, and F is the maximum quantity of the illegal nodes allowed by the blockchain network.

In one embodiment of the obtaining subunit 1221, the summation subunit 1222, and the determining subunit 1223, reference may be made to the description of the maximum quantity of illegal nodes in the embodiment corresponding to FIG. 3 above. Details are not described herein again.

The comparison unit 123 is configured to compare the configuration weight with the maximum quantity F to obtain a comparison result.

The first update unit 124 is configured to determine that the prediction result is positive if the comparison result indicates that the configuration weight is less than or equal to the maximum quantity F. The prediction result being positive indicates that the configuration weight meets the node update condition.

The update processing module 12 is configured to, when updating the node weight of the first consensus node according to the node weight update instruction in response to the prediction result being positive, to obtain the update result, specifically perform the following operation:

updating the node weight of the first consensus node according to the configuration weight in the node weight update instruction in response to the prediction result being positive, to obtain the update result, the configuration weight of the first consensus node in the update result being configured for updating the node weight list.

The discarding unit 125 is configured to determine that the prediction result is negative if the comparison result indicates that the configuration weight is greater than the maximum quantity F, and discard the node weight update instruction. The prediction result being negative indicates that the configuration weight does not meet the node update condition.

The first obtaining unit 126 is configured to obtain a configuration weight carried by the node weight update instruction, and determine by default that the prediction result is positive according to the node weight update instruction. The configuration weight is a predicted updated node weight of the first consensus node. The prediction result being positive indicates that the configuration weight meets the node update condition.

The second obtaining unit 127 is configured to obtain the node weight of the first consensus node from the blockchain network in response to the prediction result being positive.

The second update unit 128 is configured to update the node weight of the first consensus node to the configuration weight in the node weight update instruction to obtain the update result.

In embodiments of the list obtaining unit 121, the quantity determining unit 122, the comparison unit 123, the first update unit 124, the discarding unit 125, the first obtaining unit 126, the second obtaining unit 127, and the second update unit 128, reference may be made to the description of operation S102 in the embodiment corresponding to FIG. 3 above. Details are not described herein again.

The writing module 13 is configured to record the update result in a database of the blockchain network.

A target consensus node is a master node having a proposal function in the blockchain network. The target consensus node belongs to the N consensus nodes included in the blockchain network. N is a positive integer equal to (3F+1). F is the maximum quantity of the illegal nodes allowed by the blockchain network.

The writing module 13 includes: a packetizing unit 1301, a broadcast unit 1302, a counting unit 1303, a consensus determining unit 1304, a writing unit 1305, a detection unit 1306, the third obtaining unit 1307, a restarting unit 1308, a consensus unit 1309, and an information generation unit 1310.

The packetizing unit 1301 is configured to packetize the update result to obtain a to-be-verified block to be written into the blockchain network.

The broadcast unit 1302 is configured to broadcast the to-be-verified block to (N−1) backup nodes in the blockchain network such that the (N−1) backup nodes perform a consensus on an obtained to-be-verified block, to obtain a consensus result. The (N−1) backup nodes refer to consensus nodes other than the target consensus node in the N consensus nodes.

The counting unit 1303 is configured to count statistics on consensus-reached consensus results from received consensus results, and determine counted consensus-reached consensus results as a consensus result set.

The consensus determining unit 1304 is configured to determine a sum of node weights of the backup nodes corresponding to each consensus result in the consensus result set as a consensus quantity corresponding to the consensus result set.

The writing unit 1305 is configured to determine that the consensus nodes in the blockchain network reach a consensus if a ratio of the consensus quantity to the total node weight corresponding to the blockchain network reaches a consensus threshold, and write the to-be-verified block as a target block into the database of the blockchain network. The total node weight refers to a sum of the node weights of the N consensus nodes. The target block written into the database of the blockchain network is configured for indicating that an updated node weight of the first consensus node is capable of weighting the voting information of the first consensus node in the consensus service.

The detection unit 1306 is configured to detect the consensus node in an abnormal state in the blockchain network if the consensus nodes in the blockchain do not reach a consensus and the prediction result is determined to be positive by default according to the node weight update instruction, and determine a detected consensus node as the second consensus node.

The third obtaining unit 1307 is configured to obtain a node weight of the second consensus node.

The restarting unit 1308 is configured to restart the second consensus node if the node weight of the second consensus node is greater than the maximum quantity F of illegal nodes allowed by the blockchain network, and update a consensus state of the second consensus node.

The consensus unit 1309 is configured to perform a consensus on an obtained to-be-verified block again if an updated consensus state of the second consensus node is restored to a normal state.

The information generation unit 1310 is configured to generate alarm information associated with the second consensus node if the updated consensus state of the second consensus node is the abnormal state, and transmit the alarm information to a management terminal device associated with the blockchain network.

In some embodiments of the packetizing unit 1301, the broadcast unit 1302, the counting unit 1303, the consensus determining unit 1304, the writing unit 1305, the detection unit 1306, the third obtaining unit 1307, the restarting unit 1308, the consensus unit 1309, and the information generation unit 1310, reference may be made to the description of operation S103 in the embodiment corresponding to FIG. 3 above. Details are not described herein again.

The first consensus node belongs to the N consensus nodes included in the blockchain network. N is a positive integer. One consensus node corresponds to one service organization. A service organization corresponds to the first consensus node is the first service organization. The node weight update instruction is generated by the first terminal device of the first service organization in response to a configuration operation of the first object for the node weight of the first consensus node.

The obtaining module 11 is specifically configured to receive a node weight update instruction transmitted by the first terminal device. The node weight update instruction carries master signature information and multi-party signature information. The master signature information is obtained after the first terminal device performs signature on the node weight update instruction based on the first private key of the first object. The multi-party signature information is obtained after performing multi-party signature on the node weight update instruction based on second private keys of second objects associated with M second service organizations. The second service organizations are service organizations other than the first service organization in N service organizations. M is a positive integer less than N and greater than a signature threshold.

The validity verification module 15 is configured to perform validity verification on the node weight update instruction based on the first public key of the first object and the master signature information to obtain a validity verification result.

The validity verification module 15 includes: a signature verification unit 151, a checking unit 152, the first generation unit 153, and the second generation unit 154.

The signature verification unit 151 is configured to perform signature verification on the master signature information based on the first public key of the first object to obtain a master signature verification result.

The checking unit 152 is configured to check an instruction format of the node weight update instruction based on a smart contract on the blockchain network to obtain a checking result.

The first generation unit 153 is configured to generate the validity verification result for indicating that the node weight update instruction is valid if the master signature verification result indicates successful verification and the checking result indicates successful checking.

The second generation unit 154 is configured to generate a validity verification result for indicating that the node weight update instruction is not valid if the master signature verification result indicates failed verification or the checking result indicates failed checking.

Some embodiments of the signature verification unit 151, the checking unit 152, the first generation unit 153, and the second generation unit 154, reference may be made to the description of performing validity verification on the node weight update instruction in the embodiment corresponding to FIG. 3 above. Details are not described herein again.

The multi-signature verification module 16 is configured to perform multi-signature verification on the multi-party signature information based on second public keys respectively corresponding to the second objects associated with the M second service organizations if the validity verification result indicates that the node weight update instruction is valid, to obtain a multi-signature verification result.

The performing module 17 is configured to inform, when the multi-signature verification result indicates successful verification, the update processing module 12 to perform the operation of predicting whether the updated node weight of the first consensus node meets the node update condition based on the node weight update instruction, to obtain the prediction result.

If the target consensus node is the master node having the proposal function in the blockchain network and is not the first consensus node, the node weight update instruction obtained by the target consensus node is committed by the first consensus node when determining that the multi-signature verification result indicates successful verification. The multi-signature verification result is obtained by the first consensus node after performing multi-signature verification on the multi-party signature information carried in the node weight update instruction when determining that the validity verification result indicates that the node weight update instruction is valid. The validity verification result is generated by the first consensus node after performing validity verification on a received node weight update instruction.

The target consensus node is the master node having the proposal function in the blockchain network. A block including the update result in the blockchain network is the target block.

The block producing rule obtaining module 18 is configured to obtain a block producing rule associated with the blockchain network.

The target weight obtaining module 19 is configured to obtain the node weight of the target consensus node if the block producing rule is a block producing rule associated with the node weight. The node weight of the target consensus node is configured to indicate a total quantity of times of block production of the target consensus node in a current round.

The master node determining module 20 is configured to continue to determine the target consensus node as the master node having the proposal function if a quantity of times of block production of the target consensus node in the current round does not reach the total quantity of times of block production such that the target consensus node uploads a next block of the target block.

Some embodiments of the obtaining module 11, the update processing module 12, the writing module 13, the validity verification module 15, the multi-signature verification module 16, the performing module 17, the block producing rule obtaining module 18, the target weight obtaining module 19, and the master node determining module 20, reference may be made to the description of operation S101 to operation S103 in the embodiment corresponding to FIG. 3, operation S201 to operation S205 in the embodiment corresponding to FIG. 11, and operation S131 to operation S137 in the embodiment corresponding to FIG. 13 above. Details are not described herein again. In addition, the description of beneficial effects of the same method is not described herein again.

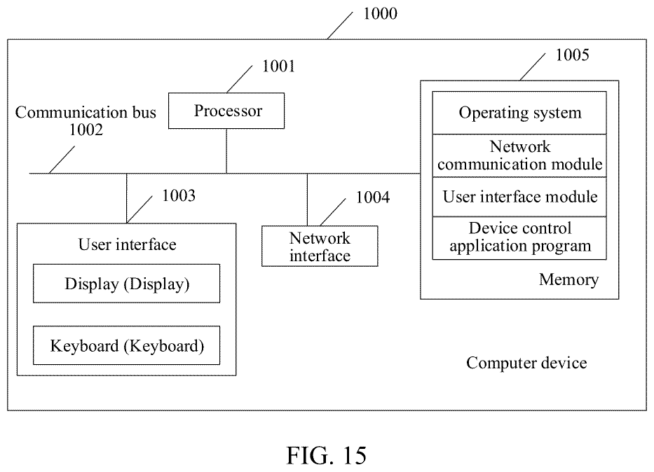

Further, referring to FIG. 15, FIG. 15 is a schematic diagram of a computer device according to an embodiment of this application. As shown in FIG. 15, a computer device 1000 may include: at least one processor 1001, e.g., a CPU, at least one network interface 1004, a memory 1005, and at least one communication bus 1002. The communication bus 1002 is configured to implement connection and communication between these components. The network interface 1004 may include a standard wired interface and wireless interface (for example, a Wi-Fi interface). The memory 1005 may be a high-speed RAM memory, or may be a non-volatile memory, such as at least one magnetic disk memory. The memory 1005 may be at least one storage apparatus that is located far away from the foregoing processor 1001. As shown in FIG. 15, the memory 1005 used as a computer storage medium may include an operating system, a network communication module, a user interface module, and a device-control application program. In some embodiments, the computer device may further include a user interface 1003 shown in FIG. 15. For example, if the computer device is a terminal device, then the computer device may further include the user interface 1003. The user interface 1003 may include a display, a keyboard and the like.

In the computer device 1000 shown in FIG. 15, the network interface 1004 is mainly configured to perform network communication. The user interface 1003 is mainly configured to provide an input interface for a user. The processor 1001 may be configured to invoke the device-control application program stored in the memory 1005 to implement:

obtaining a node weight update instruction generated for the first consensus node in a blockchain network, the node weight update instruction being configured for instructing an update of a node weight configured for voting information of the first consensus node in a consensus service;

predicting whether an updated node weight of the first consensus node meets a node update condition based on the node weight update instruction, to obtain a prediction result;

updating the node weight of the first consensus node according to the node weight update instruction in response to the prediction result being positive, to obtain an update result; and

recording the update result in a database of the blockchain network.

The computer device 1000 described in this embodiment can perform the foregoing description of the data processing method based on a blockchain network in the embodiment corresponding to FIG. 3, FIG. 11 or FIG. 13, or perform the foregoing description of the data processing apparatus 1 based on a blockchain network in the embodiment corresponding to FIG. 14. Details are not described herein. In addition, the description of beneficial effects of the same method is not described herein again.

An embodiment of this application further provides a computer-readable storage medium. The computer-readable storage medium has a computer program stored therein. The computer program includes a program instruction. The program instruction, when executed by a processor, implements the data processing method based on a blockchain network provided by the operations in FIG. 3, FIG. 11, and FIG. 13. For details, reference may be made to the implementations provided by the operations in FIG. 3, FIG. 11, and FIG. 13. Details are not described herein again.

The computer-readable storage medium may be an internal storage unit in the data transmission device provided in any one of the foregoing embodiments or the computer device, for example, a hard disk or an internal memory in the computer device. The computer-readable storage medium may also be an external storage device of the computer device, such as a plug-in hard disk, a smart media card (SMC), a secure digital (SD) card, or a flash card equipped on the computer device. Further, the computer-readable storage medium may further include both the internal storage unit and the external storage device of the computer device. The computer-readable storage medium is configured to store the computer program and other programs and data that are required by the computer device. The computer-readable storage medium may be further configured to temporarily store data that has been outputted or is to be outputted.

The embodiments of this application further provide a computer program product, including a computer program. The computer program is stored in a computer-readable storage medium. A processor of a computer device reads the computer program from the computer-readable storage medium. The processor executes the computer program, to cause the computer device to perform the descriptions of the data processing method or apparatus based on a blockchain network in the foregoing embodiments, and details are not described herein again. In addition, the description of beneficial effects of the same method is not described herein again.

The terms “first”, “second”, and the like in the specification, the claims, and the accompanying drawings of the embodiments of this application are intended to distinguish between different objects, instead of describing a particular sequence. In addition, the terms “include” and any variant thereof are intended to cover a non-exclusive inclusion. For example, processes, methods, apparatuses, products, or devices including a series of steps or units are not limited to the listed steps or modules, but instead, include steps or modules not listed in some embodiments, or include other steps or units inherent in these processes, methods, apparatuses, products, or devices in some embodiments.

A person of ordinary skill in the art may realize that, units and algorithm steps of each example described in combination with the disclosed embodiments herein can be implemented by electronic hardware, computer software, or a combination thereof. To clearly describe the interchangeability between the hardware and the software, compositions and steps of each example have been generally described based on functions in the foregoing descriptions. Whether the functions are executed in a mode of hardware or software depends on particular applications and design constraint conditions of the technical solutions. Those skilled in the art may use different methods to implement the described functions for each particular application, but such implementation is not to be considered beyond the scope of this application.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data processing method based on a blockchain, performed by a target consensus node, comprising:
obtaining a node weight update instruction generated for the first consensus node in a blockchain network, the node weight update instruction being configured for instructing an update of a node weight configured for voting information of the first consensus node in a consensus service;
predicting whether an updated node weight of the first consensus node meets a node update condition based on the node weight update instruction to obtain a prediction result;
updating the node weight of the first consensus node according to the node weight update instruction in response to the prediction result being positive to obtain an update result; and
recording the update result in a database of the blockchain network.

2. The method according to claim 1, wherein the first consensus node belongs to N consensus nodes in the blockchain network, N being a positive integer; and
the predicting whether an updated node weight of the first consensus node meets a node update condition based on the node weight update instruction to obtain a prediction result comprises:
obtaining a node weight list corresponding to the blockchain network based on the node weight update instruction, the node weight list comprising a node weight respectively corresponding to each of the N consensus nodes;
determining a maximum quantity F of illegal nodes allowed by the blockchain network based on N node weights and a configuration weight carried by the node weight update instruction, the configuration weight being a predicted updated node weight of the first consensus node;
comparing the configuration weight with the maximum quantity F to obtain a comparison result; and
determining that the prediction result is positive if the comparison result indicates that the configuration weight is less than or equal to the maximum quantity F, the prediction result being positive indicating that the configuration weight meets the node update condition.

3. The method according to claim 2, wherein the updating the node weight of the first consensus node according to the node weight update instruction in response to the prediction result being positive to obtain an update result comprises:
updating the node weight of the first consensus node according to the configuration weight in the node weight update instruction in response to the prediction result being positive, to obtain the update result, the configuration weight of the first consensus node in the update result being configured for updating the node weight list.

4. The method according to claim 2, wherein the determining a maximum quantity F of illegal nodes allowed by the blockchain network based on N node weights and a configuration weight carried by the node weight update instruction comprises:
obtaining (N−1) node weights other than the node weight of the first consensus node from the N node weights;
summing the (N−1) node weights and the configuration weight carried by the node weight update instruction to obtain a total node weight H corresponding to the blockchain network, H being a positive integer; and
determining the maximum quantity F of the illegal nodes allowed by the blockchain network based on the total node weight H and a node configuration rule corresponding to the blockchain network.

5. The method according to claim 4, wherein the node configuration rule is H=3F+1, H being the total node weight, and F being the maximum quantity of the illegal nodes allowed by the blockchain network.

6. The method according to claim 2, wherein further comprising:
determining that the prediction result is negative if the comparison result indicates that the configuration weight is greater than the maximum quantity F, and discarding the node weight update instruction, the prediction result being negative indicating that the configuration weight does not meet the node update condition.

7. The method according to claim 1, wherein the predicting whether an updated node weight of the first consensus node meets a node update condition based on the node weight update instruction, to obtain a prediction result comprises:
obtaining a configuration weight carried by the node weight update instruction, the configuration weight being a predicted updated node weight of the first consensus node; and
determining by default that the prediction result is positive according to the node weight update instruction, the prediction result being positive indicating that the configuration weight meets the node update condition; and
the updating the node weight of the first consensus node according to the node weight update instruction in response to the prediction result being positive, to obtain an update result comprises:
obtaining the node weight of the first consensus node from the blockchain network in response to the prediction result being positive; and
updating the node weight of the first consensus node to the configuration weight in the node weight update instruction to obtain the update result.

8. The method according to claim 1, wherein the target consensus node is a master node having a proposal function in the blockchain network; the target consensus node belongs to the N consensus nodes in the blockchain network; N is a positive integer equal to (3F+1); F is the maximum quantity of the illegal nodes allowed by the blockchain network; and
the recording the update result in a database of the blockchain network comprises:
packetizing the update result to obtain a to-be-verified block to be written into the blockchain network;
broadcasting the to-be-verified block to (N−1) backup nodes in the blockchain network such that the (N−1) backup nodes perform a consensus on an obtained to-be-verified block, to obtain a consensus result, the (N−1) backup nodes referring to consensus nodes other than the target consensus node in the N consensus nodes;
counting consensus-reached consensus results from received consensus results, and determining counted consensus-reached consensus results as a consensus result set;
determining a sum of node weights of the backup nodes corresponding to each consensus result in the consensus result set as a consensus quantity corresponding to the consensus result set; and
determining that consensus nodes in the blockchain network reach a consensus if a ratio of the consensus quantity to the total node weight corresponding to the blockchain network reaches a consensus threshold, and writing the to-be-verified block as a target block into the database of the blockchain network, the total node weight referring to a sum of node weights of the N consensus nodes, and a target block written into the database of the blockchain network indicating that the updated node weight of the first consensus node is capable of weighting the voting information of the first consensus node in the consensus service.

9. The method according to claim 8, wherein further comprising:
detecting a consensus node in an abnormal state in the blockchain network if the consensus nodes in the blockchain network do not reach a consensus and the prediction result is determined to be positive by default according to the node weight update instruction, and determining a detected consensus node as the second consensus node;
obtaining a node weight of the second consensus node;
restarting the second consensus node if the node weight of the second consensus node is greater than the maximum quantity F of the illegal nodes allowed by the blockchain network, and updating a consensus state of the second consensus node; and
performing a consensus on an obtained to-be-verified block again if an updated consensus state of the second consensus node is restored to a normal state.

10. The method according to claim 9, wherein further comprising:
generating alarm information associated with the second consensus node if the updated consensus state of the second consensus node is the abnormal state, and transmitting the alarm information to a management terminal device associated with the blockchain network.

11. The method according to claim 1, wherein the target consensus node is the master node having the proposal function in the blockchain network; a block comprising the update result in the blockchain network is the target block; and
the method further comprises:
obtaining a block producing rule associated with the blockchain network;
obtaining a node weight of the target consensus node if the block producing rule is a block producing rule associated with the node weight, the node weight of the target consensus node indicating a total quantity of times of block production of the target consensus node in a current round; and
continuing to determine the target consensus node as the master node having the proposal function if a quantity of times of block production of the target consensus node in the current round does not reach the total quantity of times of block production, and uploading a next block of the target block.

12. The method according to claim 1, wherein the first consensus node belongs to the N consensus nodes in the blockchain network; N is a positive integer; one consensus node corresponds to one service organization; a service organization corresponding to the first consensus node is the first service organization; the node weight update instruction is generated by the first terminal device of the first service organization in response to a configuration operation of the first object for the node weight of the first consensus node;
the obtaining a node weight update instruction generated for the first consensus node in a blockchain network comprises:
receiving a node weight update instruction transmitted by the first terminal device, the node weight update instruction carrying master signature information and multi-party signature information, the master signature information being obtained after the first terminal device performs signature on the node weight update instruction based on the first private key of the first object, the multi-party signature information being obtained after performing multi-party signature on the node weight update instruction based on second private keys of second objects associated with M second service organizations, the second service organizations being service organizations other than the first service organization in N service organizations, and M being a positive integer less than N and greater than a signature threshold; and
the method further comprises:
performing validity verification on the node weight update instruction based on the first public key of the first object and the master signature information to obtain a validity verification result;
performing multi-signature verification on the multi-party signature information based on second public keys respectively corresponding to the second objects associated with the M second service organizations if the validity verification result indicates that the node weight update instruction is valid, to obtain a multi-signature verification result; and
performing, when the multi-signature verification result indicates successful verification, the operation of predicting whether an updated node weight of the first consensus node meets a node update condition based on the node weight update instruction, to obtain a prediction result.

13. The method according to claim 12, wherein the performing validity verification on the node weight update instruction based on the first public key of the first object and the master signature information to obtain a validity verification result comprises:
performing signature verification on the master signature information based on the first public key of the first object to obtain a master signature verification result;
checking an instruction format of the node weight update instruction based on a smart contract on the blockchain network to obtain a checking result;
generating the validity verification result for indicating that the node weight update instruction is valid if the master signature verification result indicates successful verification and the checking result indicates successful checking; and
generating a validity verification result for indicating that the node weight update instruction is not valid if the master signature verification result indicates failed verification or the checking result indicates failed checking.

14. The method according to claim 1, wherein if the target consensus node is the master node having the proposal function in the blockchain network and is not the first consensus node, the node weight update instruction obtained by the target consensus node is committed by the first consensus node when determining that the multi-signature verification result indicates successful verification; the multi-signature verification result is obtained by the first consensus node after performing multi-signature verification on the multi-party signature information carried in the node weight update instruction when determining that the validity verification result indicates that the node weight update instruction is valid; and the validity verification result is generated by the first consensus node after performing validity verification on a received node weight update instruction.

15. A blockchain network, comprising:
N consensus nodes, N being a positive integer; one consensus node corresponding to one node weight; the N consensus nodes comprising the first consensus node and a target consensus node; the target consensus node being configured to obtain a node weight update instruction generated for the first consensus node in the blockchain network, and the node weight update instruction being configured for instructing an update of a node weight configured for voting information of the first consensus node in a consensus service; the target consensus node being further configured to predict whether an updated node weight of the first consensus node meets a node update condition based on the node weight update instruction, to obtain a prediction result; and the target consensus node being further configured to update the node weight of the first consensus node according to the node weight update instruction in response to the prediction result being positive, to obtain an update result, and record the update result in a database of the blockchain network.

16. The blockchain network according to claim 15, wherein the first consensus node is configured to broadcast the node weight update instruction to the target consensus node when determining that an instruction verification result of the node weight update instruction indicates successful verification; the instruction verification result is determined by the first consensus node based on a validity verification result and a multi-signature verification result; the validity verification result is generated by the first consensus node after performing validity verification on the node weight update instruction; and the multi-signature verification result is obtained by the first consensus node after performing multi-signature verification on multi-party signature information carried in the node weight update instruction when determining that the validity verification result indicates that the node weight update instruction is valid.

17. A computer device, comprising: a processor and a memory, and a network interface;
the processor being connected to the memory and the network interface, the network interface being configured to provide a data communication function, the memory being configured to store a computer program, and the processor being configured to invoke the computer program to cause the computer device to perform a data processing method based on a blockchain, performed by a target consensus node, comprising:
obtaining a node weight update instruction generated for the first consensus node in a blockchain network, the node weight update instruction being configured for instructing an update of a node weight configured for voting information of the first consensus node in a consensus service;
predicting whether an updated node weight of the first consensus node meets a node update condition based on the node weight update instruction to obtain a prediction result;
updating the node weight of the first consensus node according to the node weight update instruction in response to the prediction result being positive to obtain an update result; and
recording the update result in a database of the blockchain network.

18. The computer device according to claim 17, wherein the first consensus node belongs to N consensus nodes in the blockchain network, N being a positive integer; and
the predicting whether an updated node weight of the first consensus node meets a node update condition based on the node weight update instruction to obtain a prediction result comprises:
obtaining a node weight list corresponding to the blockchain network based on the node weight update instruction, the node weight list comprising a node weight respectively corresponding to each of the N consensus nodes;
determining a maximum quantity F of illegal nodes allowed by the blockchain network based on N node weights and a configuration weight carried by the node weight update instruction, the configuration weight being a predicted updated node weight of the first consensus node;
comparing the configuration weight with the maximum quantity F to obtain a comparison result; and
determining that the prediction result is positive if the comparison result indicates that the configuration weight is less than or equal to the maximum quantity F, the prediction result being positive indicating that the configuration weight meets the node update condition.

19. The computer device according to claim 18, wherein the updating the node weight of the first consensus node according to the node weight update instruction in response to the prediction result being positive to obtain an update result comprises:
updating the node weight of the first consensus node according to the configuration weight in the node weight update instruction in response to the prediction result being positive, to obtain the update result, the configuration weight of the first consensus node in the update result being configured for updating the node weight list.

20. The computer device according to claim 18, wherein the determining a maximum quantity F of illegal nodes allowed by the blockchain network based on N node weights and a configuration weight carried by the node weight update instruction comprises:
obtaining (N−1) node weights other than the node weight of the first consensus node from the N node weights;
summing the (N−1) node weights and the configuration weight carried by the node weight update instruction to obtain a total node weight H corresponding to the blockchain network, H being a positive integer; and
determining the maximum quantity F of the illegal nodes allowed by the blockchain network based on the total node weight H and a node configuration rule corresponding to the blockchain network.
